(19) United States
(12) Patent Application Publication
(10) Pub. No.: US 2007/0244990 A1
(43) Pub. Date: Oct. 18, 2007

(54) Web browser graph user interface element with rich interactive capabilities

(75) Inventor: Elton R. Wells, Round Rock, TX (US)

Correspondence Address: MEYERTONS, HOOD, KIVLIN, KOWERT & GOETZEL, P.C., P.O. BOX 398, AUSTIN, TX, 78767-0398, US

(73) Assignee: National Instruments Corporation

(21) Appl. No.: 11/396,740

(22) Filed: Apr. 3, 2006

(51) Int. Cl. G06F 15/16

(52) U.S. Cl. 709/218

(57) ABSTRACT

A system and method for graphing data for a web application. A developer associates a graph component with a web page. In response to a web browser accessing the web page, the web server executes the graph component. The graph component generates information useable to display a graph in the web browser and generates scripting code which enables the user to interact with the graph in various ways. In response to the user interacting with the graph, the scripting code asynchronously communicates with the graph component on the web server to receive information for updating the graph displayed in the web browser.

### FIELD OF THE INVENTION

The present invention relates to the field of test and measurement systems that acquire measurement data from a system or device under test. The invention also relates to the field of web applications. More particularly, the invention relates to a system and method for graphing measurement data in a standard web browser without requiring any plug-in software to be installed in the web browser.

### DESCRIPTION OF THE RELATED ART

Scientists and engineers use measurement devices or instruments to perform a wide variety of functions that involve measuring properties of a physical system or device under test (DUT), e.g., to perform test and analysis of physical systems or devices, process monitoring and control, control of mechanical or electrical machinery, laboratory research, hardware-in-the-loop testing, and simulation functions, to name a few examples. Systems that use measurement devices to perform such measurement and/or control functions are collectively referred to herein as “measurement systems,” and the devices or instruments used to acquire data from the physical system or DUT are referred to herein as “measurement devices”.

A measurement system may include measurement devices for measuring various types of physical, mechanical, electrical, chemical, or thermodynamic elements, among others, or some combination of such elements. For example, a measurement system may acquire measurement data from an engine or engine component, a device in motion, a chemical reaction, a petroleum refining process, a system of liquids flowing among different tanks, etc.

The measurement system may include one or more sensors operable to sense one or more variables of the physical system or DUT and one or more transducers operable to output a signal based on the one or more variables. The sensors and transducers may be operable to sense any of various types of system variables, depending on the type of physical system. Examples of system variables that may be sensed include variables related to: motion and force (acceleration, altitude, displacement, force, torque, pressure, velocity, strain, etc.), fluid conditions (flow, pressure, liquid level, etc.), electromagnetism (light, radioactivity, voltage, current, etc.), chemistry, sound, temperature, humidity, proximity, etc. The sensors and transducers may comprise any of various types of devices operable to sense the variables of interest and produce an output signal based on the variables. The output signals produced by the transducers are most typically an electrical signal, but may also be other types of signals.

The output signal from a transducer is typically received by a measurement device, which generates measurement data characterizing the output signal. The measurement data may in turn be received by a computer system coupled to the measurement device. In modern measurement systems, computer systems typically analyze the measurement data received from the measurement device and may also generate output signals to provide feedback to the physical system or DUT to form a control loop, depending on the particular application.

Measurement systems are moving toward network-based or distributed systems, where the computer system that receives the measurement data is connected to other computer systems by a network. It is often necessary or highly desirable to enable the measurement data to be displayed on these remote computer systems.

In recent years, network communication protocols and software used in accessing web pages on the World Wide Web have emerged as standards enabling client computer systems to receive and display data from server computer systems. In particular, web browser software has emerged as a standard software application found on most computer systems connected to the Internet or an Intranet. Thus, it would be desirable to enable standard web browsers to receive and display measurement data originating from a measurement system.

The scientists and engineers that implement measurement systems are often not highly trained in the art of computer programming, and in particular, may not be trained to perform networking tasks involving data exchange. Thus, it would be desirable to simplify the task of implementing a web application for displaying measurement data in web browsers on client computer systems.

### SUMMARY OF THE INVENTION

One embodiment of the present invention comprises a system and method for graphing data for a web application. A web browser on a client computer system requests a web page from a server computer system, and the server computer system returns the web page to the client computer system. The web page returned to the client computer system includes first information useable to display a graph illustrating first data. For example, displaying the graph may comprise displaying a two-dimensional plot of the first data or a three-dimensional plot of the first data. In one embodiment the first data illustrated in the graph may comprise measurement data acquired from a measurement device.

The web page may also include scripting code associated with the graph. The scripting code associated with the graph may enable a user to interact with the graph in various ways in order to request second data to be illustrated in the graph.

As one example, in one embodiment the scripting code may enable the user to provide input selecting a subset of the first data illustrated in the graph in order to request the subset of the first data to be illustrated in the graph at a larger scale. For example, in one embodiment the user may be able to draw a box around the subset of the first data, e.g., to request to “zoom in” on the subset of the first data to view it in more detail.

As another example, in one embodiment the scripting code may enable the user to provide input to an axis of the displayed graph in order to change its axis range. Changing the axis range may signify a user request to update the graph to illustrate data within the new axis range.

In response to the user input requesting the second data to be illustrated in the graph, the scripting code associated with the graph operates to asynchronously request the server computer system to return second information useable to re-display the graph to illustrate the second data. The server computer system returns the second information to the client computer system in response to the asynchronous request. The scripting code associated with the graph operates to re-display the graph to illustrate the second data based on the second information. In one embodiment, the scripting code may be operable to perform an animation effect to animate a transition from the first data illustrated in the graph to the second data illustrated in the graph.

By performing the request to return the second information asynchronously, the graph can be re-displayed without blocking user interaction with the web page. Also, the graph may be re-displayed without re-displaying the entire web page.

The method described above may serve to provide the user with a rich interactive experience with the graph displayed in the web page, e.g., by allowing the user to perform rubber band selections of zoom regions and directly edit axis ranges, by displaying animation effects when the graph is updated with new data, and by updating the graph without re-displaying the entire web page and without blocking user interaction with the web page.

In the preferred embodiment, the web page returned to the client computer system does not require the web browser to have any plug-in software installed in order to achieve the functionality described above. For example, the web page may include only elements understood by a standard web browser, such as markup language code (e.g., HTML), images (e.g., GIF or JPG images), and scripting code (e.g., Javascript).

According to a further embodiment of the method, a re-useable software component for graphing data in web applications may be utilized on the server computer system. For example, the re-usable software component may be provided to a developer as part of a software development kit. For example, the software component may be provided as an ASP.NET control or other type of re-useable software component. The developer may associate the re-useable software component with the web page of the web application so that the software component executes on the server computer system in response to requests to access the web page.

For example, when the web browser requests to access the web page, the server computer system may execute the software component. In one embodiment the software component may execute to generate the first information useable by the web browser to display the graph illustrating the first data. In one embodiment the software component may also execute to generate the scripting code associated with the graph.

The server computer system may also execute the software component in response to the asynchronous request for the second information useable to re-display the graph to illustrate the second data. The software component may execute to generate the second information in response to the asynchronous request.

In one embodiment the developer may not need to write program code for the software component to implement the above-described functionality, or may only need to write a small amount of simple program code. Thus, the re-useable software component may enable a software developer to easily configure a web application to implement a graph such as described above for display in web browsers executing on client computer systems.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary system including a client computer system and a web server computer system which operate together to implement a method for displaying a data graph with interaction capabilities in a web page on the client computer system;

FIG. 2 illustrates an embodiment in which the web page comprises HTML code, Javascript code, and images;

FIG. 3A illustrates an exemplary instrumentation control system;

FIG. 3B illustrates an exemplary industrial automation system;

FIG. 4 is a block diagram representing one embodiment of the web server computer system illustrated in FIG. 1;

FIG. 5 is a flowchart diagram illustrating one embodiment of a method for graphing data in a web browser;

FIG. 6 illustrates an example of a graph displayed in a web browser;

FIG. 7 illustrates an example in which the user has selected a subset of the data illustrated in the graph of FIG. 6;

FIG. 8 illustrates an example in which the graph of FIGS. 6 and 7 has been re-displayed to illustrate the subset of data selected by the user in FIG. 7 at a larger scale;

FIGS. 9-11 illustrate an example in which the user edits an X-axis range of the graph by typing directly into a portion of the axis displayed in the web browser, which causes the graph to be re-displayed to illustrate data within the specified axis range;

FIGS. 12A-12B illustrate one embodiment of a method for utilizing a re-useable graph component for graphing data in web applications;

FIGS. 13 and 14 illustrate the use of an exemplary graph component in a web application, wherein the graph component is implemented as an ASP.NET control;

FIG. 15 is a diagram illustrating an overview of communication performed between the client computer system and the web server computer system in order to implement interactive graphing behavior;

FIG. 16 illustrates one embodiment of a system that implements a web application operable to simultaneously refresh a plurality of user interface elements displayed in a web page of a web browser at periodic intervals;

FIG. 17 is a flowchart diagram illustrating one embodiment of a method for periodically re-displaying a plurality of user interface elements in a web browser in a simultaneous fashion;

FIG. 18 illustrates an example of three user interface elements displayed in a web browser;

FIG. 19 illustrates an example in which the three user interface elements shown in FIG. 18 have been re-displayed simultaneously;

FIGS. 20A-20C illustrate one embodiment of a method for utilizing a re-useable auto-refresh software component and re-useable user interface software components for periodically refreshing user interface elements in web applications;

FIGS. 21-27 illustrate the use of an exemplary auto-refresh software component and exemplary user interface software components, where the components are implemented as ASP.NET controls; and

FIG. 28 is a diagram illustrating an overview of communication performed between the client computer system and the web server computer system in order to periodically re-display a plurality of user interface elements in a web browser in a simultaneous fashion.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Terms

The following is a glossary of terms used in the present application:

Computer System—Any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Software Program—The term “software program” is intended to have the full breadth of its ordinary meaning, and includes any type of program instructions and/or data that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; and other types of executable software. A software program may comprise two or more software programs that interoperate in some manner.

Web Browser—The term “web browser” is intended to have the full breadth of its ordinary meaning, and includes any software program that executes on a client computer system to communicate with a server computer system to receive resources, e.g., web pages, using the HTTP (Hypertext Transfer Protocol) communication protocol. The web browser typically renders at least a portion of the information received from the server computer system into displayable information on a display device of the client computer system. The web browser may also communicate with the server computer system using other communication protocols in addition to the HTTP protocol.

Standard Web Browser—The term “standard web browser” is intended to have the full breadth of its ordinary meaning, and includes any web browser in widespread use by a large proportion of client computer systems connected to the Internet. Standard web browsers currently in use include Internet Explorer web browsers and Firefox web browsers.

Web Page—The term “web page” is intended to have the full breadth of its ordinary meaning, and includes any information returned by a web server computer system to a web browser in response to the web browser requesting to access a resource identified by a URL (Uniform Resource Locator), where the information returned includes markup language code (e.g., HTML or other markup language code).

Web Server Computer System—The term “web server computer system” is intended to have the full breadth of its ordinary meaning, and includes any server computer system that is operable to respond to client computer systems requesting to access resources identified by URLs by returning web pages corresponding to the URLs.

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—A memory medium as described above, as well as signals such as electrical, electromagnetic, or digital signals, conveyed via a communication medium such as a bus, network and/or a wireless link.

Measurement Device—Includes instruments, data acquisition devices, smart sensors, and any of various types of devices that are operable to generate and/or store data characterizing a signal received from a physical system or device. As described above, the measurement device may receive the signal from a sensor coupled to the physical system or device, where the sensor may sense any of various types of system variables, such as variables related to: motion and force (acceleration, altitude, displacement, force, torque, pressure, velocity, strain, etc.), fluid conditions (flow, pressure, liquid level, etc.), electromagnetism (light, radioactivity, voltage, current, etc.), chemistry, sound, temperature, humidity, proximity, etc. The data generated by the measurement device in response to the signal is also referred to as data “acquired” by the measurement device.

A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Measurement Data—The data generated by a measurement device in response to the signal received from the physical system or device under test.

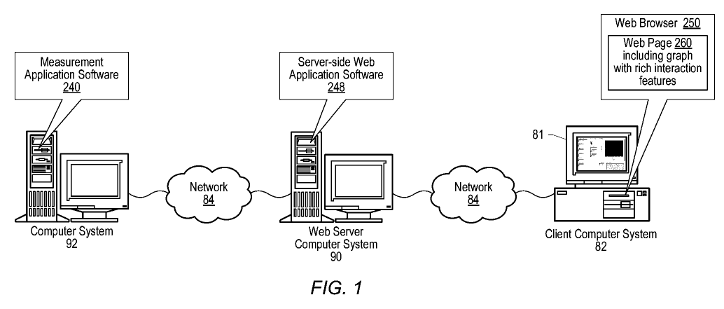

FIG. 1

FIG. 1 illustrates an exemplary system including a client computer system 82 coupled to a web server computer system 90 by a network 84. The client computer system 82 and the web server computer system 90 may each be any of various types of computer systems. The network 84 can also be any of various types, including a LAN (local area network), WAN (wide area network), the Internet, or an Intranet, among others, or some combination of such networks.

As shown in FIG. 1, the computer system 82 includes a display device 81 for displaying information. The client computer system 82 and the web server computer system 90 may operate together to implement a method for displaying a graph illustrating data on the display device of the client computer system 82. More particularly, the client computer system executes a web browser software program 250. The web browser 250 requests a web page 260 from the web server computer system 90. In response to the request for the web page, the web server computer system 90 executes server-side web application software 248 in order to retrieve or generate the web page 260, and the web server computer system 90 returns the web page 260 to the client computer system 82.

The web page 260 returned to the client computer system includes first information useable by the web browser 250 to display a graph illustrating first data on the display device 81 of the client computer system 82. The web page 260 also includes code associated with the graph in the web page 260. The code associated with the graph may implement functionality that allows the user to interact in various ways with the graph displayed in the web page 260. Some of the user's interactions with the graph may require the data illustrated in the graph to be updated or replaced with new data. For example, the user may request to zoom in to portions of the displayed data to view them in more detail or to perform other interactive operations such as described below. When new data needs to be illustrated in the graph, the code associated with the graph may communicate with the server-side web application software 248 on the web server computer system 90 in order to obtain information useable for re-displaying the graph to illustrate the new data. One embodiment of a method for displaying the graph with initial data and subsequently re-displaying the graph to illustrate different data is described in more detail below.

In one embodiment the server-side web application software 248 may utilize a re-useable software component for displaying the graph in the web browser and for generating the information for re-displaying the graph. The re-useable software component may enable a developer to easily configure the web application to perform the graphing functionality described herein. One embodiment of such a re-useable software component is described below.

In one embodiment the graph displayed in the web page 260 may illustrate measurement data. In the exemplary system illustrated in FIG. 1, the web server computer system 90 is coupled to another computer system 92 by a network 84. The computer system 92 may execute measurement application software 240, e.g., in order to interact with or control one or more measurement devices to acquire measurement data from a physical system or unit under test. The server-side web application software 248 executing on the web server computer system 90 may communicate with the measurement application software 240 executing on the computer system 92 in order to receive measurement data to be illustrated in the graph in the web page 260 on the client computer system 82.

The graph displayed in the web page 260 may include rich interactive capabilities which are enabled by the code associated with the graph. For example, the user may be able to interactively select zoom regions and interactively edit axis ranges, and the graph's appearance may be updated in response to the user's actions.

In many prior art web applications, updating a user interface element within a web page involves the web browser synchronously communicating with the web server in order to receive an updated version of the web page. In a synchronous data exchange model between a web browser and a web server, the web browser sends a request for data (e.g., a request for the updated version of the web page) to the web server and waits for a response while the web server prepares the requested data. The user may be blocked from interacting with the web page during the time that the web browser is waiting for the web server to return the updated version of the web page. Once the updated web page is received, the entire web page is typically refreshed (re-displayed) in the web browser, using the updated version of the web page.

This synchronous communication between the web browser and the web server results in the “click, wait, and refresh” interaction model that users often experience when interacting with many web applications. As a result, the user's experience of interacting with the web application is significantly different than what the user experiences when interacting with a traditional desktop application that executes in a standalone fashion on the user's computer system. As noted above, the user may be blocked from interacting with the web page during the time that the web browser is synchronously waiting for the web server to return the updated version of the web page. Also, when the web page is refreshed, the web browser window may be momentarily cleared, and the entire web page may be re-displayed using the updated version of the web page. Thus, the user sees the web browser window momentarily go blank before re-appearing. The result is that the user experiences his interaction with the web application as being somewhat awkward.

In contrast to this approach, the method described herein may involve the code associated with the graph in the web browser communicating asynchronously with the web server computer system 90 to receive the information useable for re-displaying the graph in response to the user's actions. In an asynchronous data exchange model between a web browser and a web server, the web browser (e.g., the code associated with the graph in the web browser) sends a request for data to the web server, but does not wait to receive a response while the web server prepares the requested data. Instead, the web server prepares the response and then initiates a new communication with the web browser once the requested data is ready in order to send the requested data to the web browser. For example, in one embodiment, in the initial phase in which the web browser sends the asynchronous data request to the web server, the web browser may specify a callback code routine for the web server to call back into once the requested data is ready. Any of various communication protocols may be used to exchange data in an asynchronous manner. In one embodiment the web browser may perform an asynchronous XMLHTTP request in order to request the data from the web server.

(It is noted that in the initial phase in which the web browser sends the asynchronous data request to the web server, the web browser may in fact receive a response message immediately in reply to the request, e.g., depending on the particular communication protocol used to send the request, but the response message does not include the requested data. Instead, the requested data is sent in another communication phase initiated by the server.)

Because the code associated with the graph communicates asynchronously with the web server in order to receive the information useable for re-displaying the graph, the user's interaction with the web page 260 may not be blocked while the information for re-displaying the graph is being prepared on the web server.

Also, the information for re-displaying the graph may be returned to the web browser without returning other portions of the web page. The code associated with the graph may be operable to re-display the graph based on this information, without causing the entire web page to be re-displayed. Thus, the user's experience of interacting with the web application may be similar to what the user experiences when interacting with a traditional desktop application that executes in a standalone fashion on the user's computer system.

However, in the preferred embodiment, the web page 260 does not require the web browser to have any plug-in software installed in order to achieve this type of interactive experience. In other words, the web page 260 includes only elements understood by (i.e., able to be processed by) a standard web browser and does not include elements not understood by a standard web browser. Standard web browsers understand markup language code, such as HTML. Standard web browsers also understand scripting code, such as Javascript. As used herein, the term “scripting code” refers to program code that is received by the web browser in textual form (i.e., not in machine language or in a compiled form) and interpreted by the web browser. Standard web browsers also understand how to display images, such as GIF or JPG images.

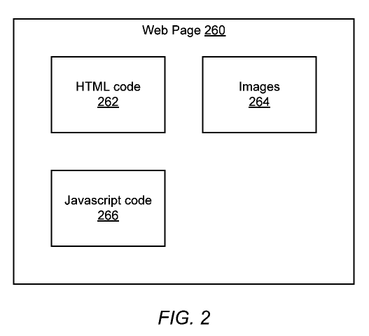

FIG. 2 illustrates an embodiment in which the web page 260 comprises HTML code 262, Javascript code 266, and images 264. The graph may be displayed in the web browser as an image, e.g., a GIF or JPG image. The Javascript code 266 may comprise the code associated with the graph. The Javascript code 266 may enable the user to interact with the graph image as described herein and may asynchronously communicate with the web server computer system 90 to re-display the graph as necessary, in response to the user's actions.

Exemplary Measurement Systems

Embodiments of the methods described herein may be used to remotely monitor or control applications involved with performing test and/or measurement functions; controlling and/or modeling instrumentation or industrial automation hardware; modeling and simulation functions, e.g., modeling or simulating a device or product being developed or tested, etc. For example, as described above, in one embodiment the web server computer system 90 may communicate with a computer system 92 that executes measurement application software 240. However, it is noted that the methods can be used for a plethora of applications and are not limited to the above applications. In other words, applications discussed in the present description are exemplary only, and the methods may be used in any of various types of systems.

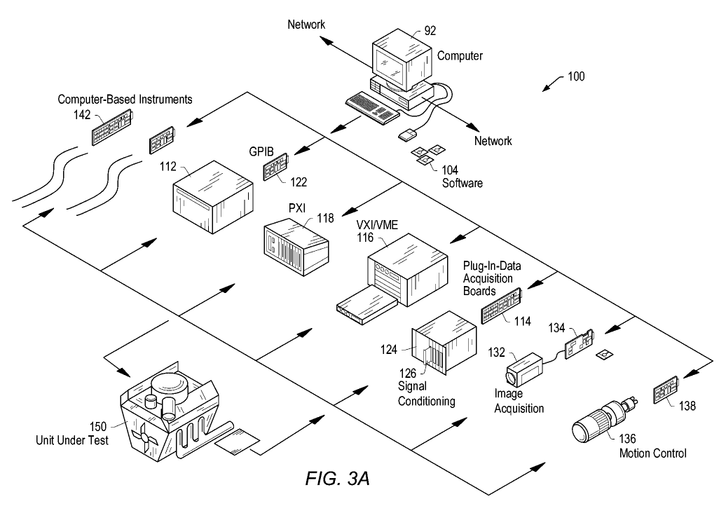

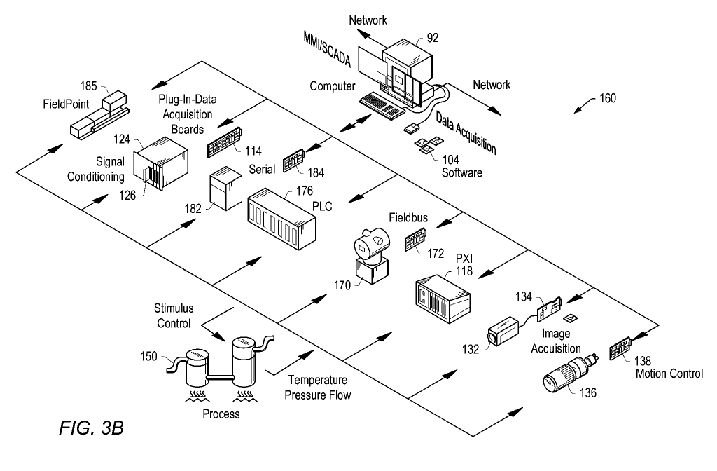

FIG. 3A illustrates an exemplary instrumentation control system 100. The system 100 comprises the host computer 92 which connects to one or more instruments. The host computer 92 may comprise a CPU, a display screen, memory, and one or more input devices such as a mouse or keyboard as shown. The computer 92 may execute the measurement application software 240, which may interact with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system 92 may couple to and operate with one or more of these instruments. The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application.

FIG. 3B illustrates an exemplary industrial automation system 160. The industrial automation system 160 is similar to the instrumentation control system 100 shown in FIG. 3A. Elements which are similar or identical to elements in FIG. 3A have the same reference numerals for convenience. The system 160 comprises the computer 92 which connects to one or more devices or instruments. The computer 92 may comprise a CPU, a display screen, memory, and one or more input devices such as a mouse or keyboard as shown. The computer 92 may execute the measurement application software 240, which may operate with the one or more devices to a process or device 150 to perform an automation function, such as MMI (Man Machine Interface), SCADA (Supervisory Control and Data Acquisition), portable or distributed data acquisition, process control, advanced analysis, or other control.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In some embodiments of the systems of FIGS. 3A and 3B, one or more of the various devices may couple to each other over a network, such as the Internet.

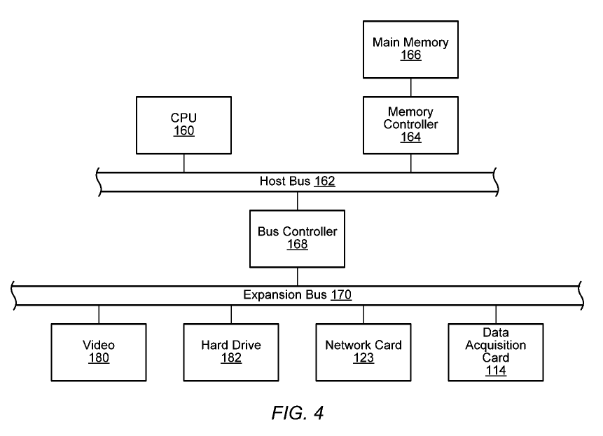

FIG. 4—Computer System Block Diagram

FIG. 4 is a block diagram representing one embodiment of the web server computer system 90 illustrated in FIG. 1. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer system 90 may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the server-side web application software 248. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 90 further comprises a video display subsystem 180 and hard drive 182 coupled to the expansion bus 170.

As shown, a network card 123 may be connected to the computer 90. The network card 123 may enable the computer 90 to communicate with other computers, such as the computer 82 and/or the computer 92. As described above, in one embodiment the computer 90 may communicate with the computer 92, which executes the measurement application software 240. The computer 90 may receive measurement data from the measurement application software 240 on the computer 92 and may generate information for displaying the measurement data in a graph in the web browser 250 on the client computer system 82.

In another embodiment, the computer system 90 may itself acquire the measurement data, instead of communicating with another computer to acquire the measurement data. For example, a measurement device such as a DAQ (Data Acquisition) card 114 may be connected to the computer system 90. Thus, the computer system 90 may execute measurement application software in order to acquire measurement data via the DAQ card 114.

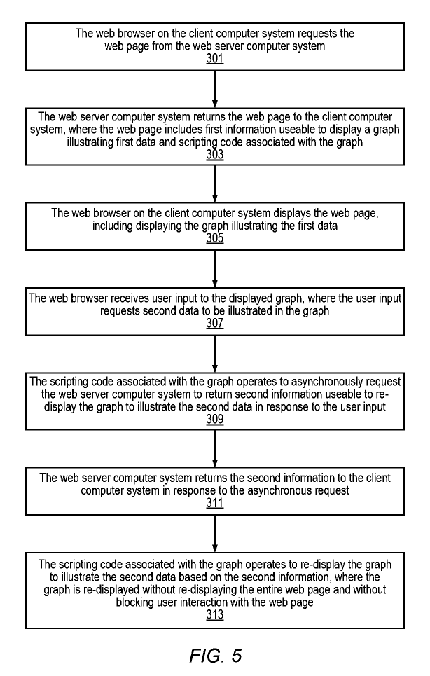

FIG. 5—Method for Graphing Data in a Web Browser

Referring now to FIG. 5, a flowchart diagram illustrating one embodiment of a method for graphing data in a web browser is shown. It is noted that FIG. 5 illustrates a representative embodiment, and alternative embodiments are contemplated. Also, various elements may be combined, omitted, or performed in different orders.

In 301 the web browser 250 on the client computer system 82 requests the web page 260 from the web server computer system 90, e.g., by performing an HTTP request referencing a URL of the web page.

In 303, the web server computer system 90 returns the web page 260 to the client computer system 82. As discussed above with reference to FIG. 2, in one embodiment the web page 260 includes HTML code (or other markup language code), Javascript code (or other scripting code), and one or more images (e.g., JPG or GIF images). As known in the art, images are typically retrieved using a separate request for each image. Thus, 301 and 303 may involve the web browser 250 performing multiple requests, e.g., a first request referencing the URL of the web page, and one or more subsequent requests referencing images or other elements identified by the HTML code returned for the web page.

The web page 260 includes first information useable by the web browser 250 to display a graph illustrating first data. In one embodiment the graph may simply be displayed as an image, such as a JPG image, a GIF image, or an image in another image format. In one embodiment, in response to the request for the web page 260, the web server computer system 90 may dynamically generate an image illustrating a graph of the first data and store this image as a file. Returning the web page 260 to the client computer system 82 may comprise returning HTML code or other markup language code, where the HTML code includes a tag referencing the generated image file. For example, the tag may specify a URL referencing the image. Thus, the web browser 250 may communicate with the web server computer system 90 to receive the image of the graph.

The web page 260 also includes scripting code associated with the graph. In one embodiment the scripting code comprises Javascript code. The scripting code associated with the graph operates as described below.

In 305, the web browser 250 on the client computer system 82 displays the web page 260. Displaying the web page 260 includes displaying the graph illustrating the first data. For example, where the graph is a simple image, displaying the web page 260 includes displaying the image of the graph. In one embodiment, displaying the graph may comprise displaying multiple images, where the multiple images are displayed in relation to each other so that they illustrate the graph. Also, in one embodiment displaying the graph may comprise displaying other kinds of elements in addition to an image. For example, in one embodiment the main portion of the graph which illustrates the data may be displayed as an image, but the graph's axes may be displayed using text indicators or other types of user interface elements.

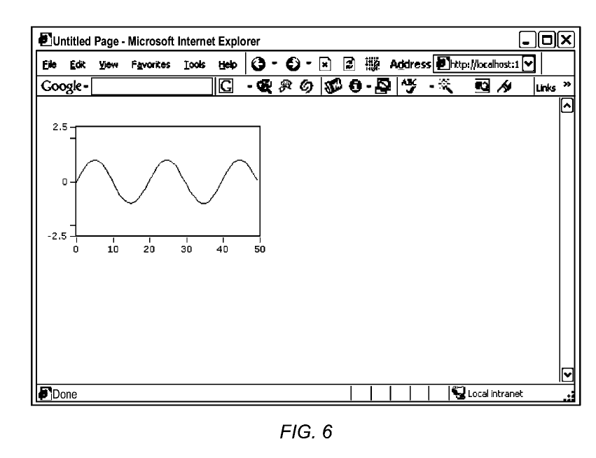

FIG. 6 illustrates one example of a graph displayed in a web browser. In this example, the graph simply illustrates a two-dimensional plot of waveform data, where the graph has two axes. In other embodiments, other types of graphs may be displayed in the web page 260. For example, in one embodiment the graph may illustrate a three-dimensional plot of data, where the graph has three axes.

The scripting code associated with the graph may enable the user to interact with the displayed graph in various ways. Some of the user's interactions with the graph may signify a desire to re-display the graph to illustrate second data. In other words, the user may provide input to the displayed graph, where the user input requests the second data to be displayed in the graph, as indicated in block 307. In response, the scripting code associated with the graph operates to asynchronously request the web server computer system 90 to return second information useable to re-display the graph to illustrate the second data, as indicated in 309. In one embodiment this asynchronous request may be performed as an XMLHTTP request.

In 311, the web server computer system 90 creates and/or retrieves the second information and returns the second information to the client computer system 82 in response to the asynchronous request. In 313, the scripting code associated with the graph operates to re-display the graph to illustrate the second data based on the second information.

As one example of steps 307-313, the scripting code associated with the graph may enable the user to “zoom in” on a subset of the first data illustrated in the graph to view it in more detail. In 307, the user may provide input to the displayed graph in order to select the subset of the first data illustrated in the graph. Selecting the subset of the first data may signify a request for the subset of the first data to be illustrated in the graph at a larger scale. In various embodiments the user may interact with the displayed graph in any of various ways to select the subset of the first data. In one embodiment, the user may select the subset of the first data by providing user input to draw a box around the subset of the first data illustrated in the graph. For example, the user may click on the graph with a pointing device to establish one corner of the box and then drag the pointer to where the user desires the opposite corner of the box to be. The box may grow and shrink as the user drags the pointer around, with one corner of the box anchored at the point where the user initially clicked. When the box is around the region the user wants to zoom in on to see in closer detail, the user may release the pointing device to establish the selection of that region.

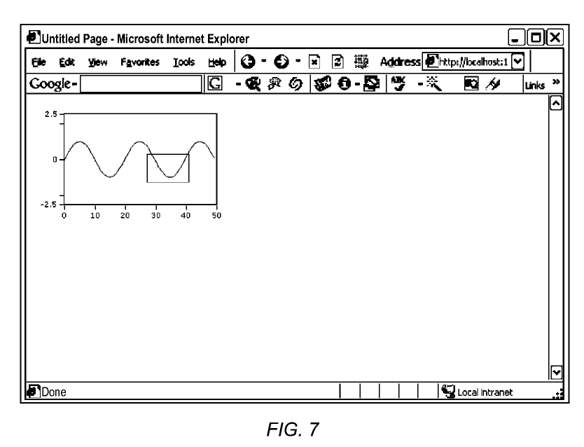

The scripting code associated with the graph may utilize Dynamic HTML (DHTML) or other features supported by the web browser 250 in order to allow the user to draw the box around the subset of the first data illustrated in the graph. In one embodiment the scripting code may also be operable to alter the appearance of the selected region in various other ways in addition to drawing the box around the selected region, e.g., using alpha blending or other highlighting techniques. FIG. 7 illustrates an example in which the user has selected a subset of the data illustrated in the graph of FIG. 6. As shown, a box has been drawn around the region bounding the data subset, and the area within the box has been highlighted using alpha blending.

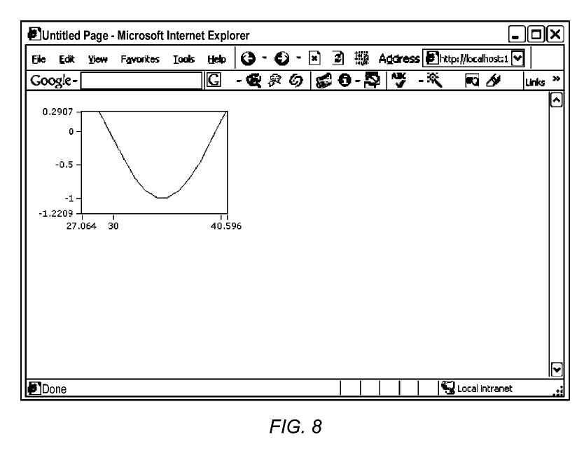

In response to the user selecting the subset of the first data, the scripting code associated with the graph operates to asynchronously request the web server computer system 90 to return second information useable to re-display the graph to illustrate the subset of the first data at a larger scale. For example, the scripting code may pass the web server computer system 90 information indicating the area within the graph that was selected by the user. The web server computer system 90 may then generate information useable to re-display the graph in the web browser 250 to illustrate the subset of the first data at a larger scale and return this information to the client computer system 82. The scripting code associated with the graph may then operate to re-display the graph to illustrate the subset of the first data at the larger scale, based on the information received from the web server computer system 90. FIG. 8 illustrates an example in which the graph of FIGS. 6 and 7 has been re-displayed to illustrate the subset of data selected by the user in FIG. 7 at a larger scale.

As noted above, in one embodiment the graph may be displayed in the web browser as an image. In this embodiment, when the web server computer system 90 receives the asynchronous request, the web server computer system 90 may generate a new image for the graph, where the new image illustrates the selected subset of data in closer detail. Thus, the scripting code may re-display the graph in the web browser by replacing the original image with the new image of the graph. In one embodiment, when the graph is re-displayed, the scripting code associated with the graph may be operable to perform an animation effect to animate a transition from the first data illustrated in the graph to the subset of the first data. For example, in one embodiment the scripting code may cause the box drawn by the user to expand in an animated fashion until reaching the borders of the graph, thus graphically indicating that the displayed axis ranges of the graph have been changed to match the axis ranges of the selected region.

As described above, by communicating with the web server computer system 90 asynchronously to receive the information for re-displaying the graph, the user may not be blocked from interacting with the web page during this time. Also, the scripting code associated with the graph preferably causes the graph to be re-displayed without re-displaying the entire web page, e.g., without re-displaying elements of the web page other than the graph. For example, the scripting code may utilize a Document Object Model supported by the web browser to cause only the graph to be re-displayed.

As another example of steps 307-313, the scripting code associated with the graph may enable the user to change the data that is illustrated in the graph by changing the axis range for one or more of the graph's axes. For example, the graph may include an X-axis, where the graph is initially displayed such that the X-axis has a first axis range. In 307, the user may provide input to the displayed graph in order to change the first axis range to a new axis range. Changing the range of the X-axis may signify a request to re-display the graph so that it illustrates data within the new axis range.

In response to the user changing the axis range, the scripting code associated with the graph operates to asynchronously request the web server computer system 90 to return second information useable to re-display the graph to illustrate the data within the new axis range. For example, if the user narrows the axis range then the web server computer system 90 may generate information useable to re-display the graph in order to zoom in to view the portion of data within the new axis range at a larger scale. If the user widens the axis range then the web server computer system 90 may generate information useable to re-display the graph in order to zoom out to view the data at a smaller scale. In this case the graph may illustrate a superset of the first data that was originally displayed in the graph, if data exists at a wider range than was initially displayed.

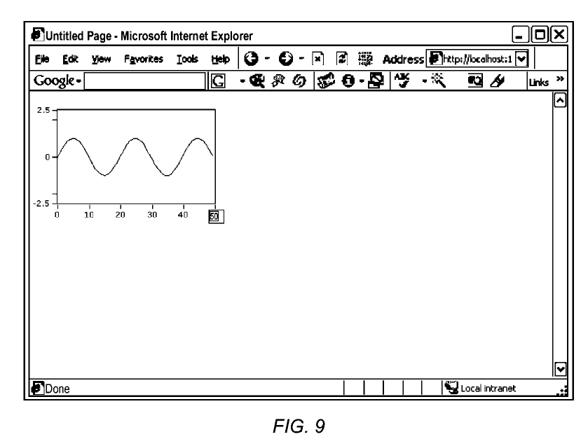

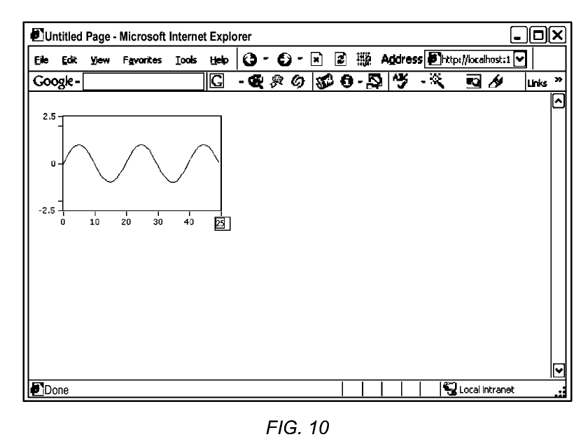

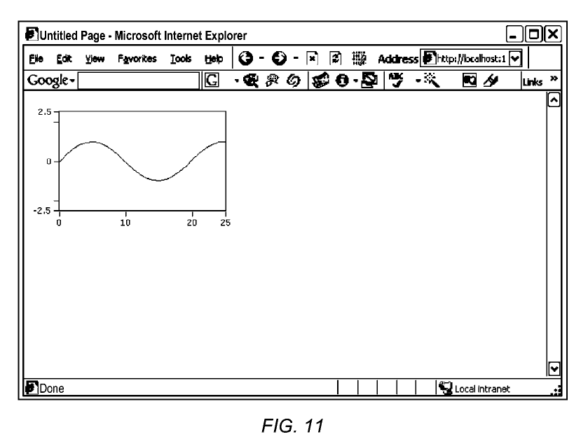

In various embodiments, the user may interact with the graph in any of various ways in order to change the axis range. As noted above, in one embodiment an axis of the graph may be represented using user interface elements other than an image. The user may be able to interact directly with the user interface elements representing the axis in order to edit the axis range. FIG. 9 illustrates an example in which the user edits the X-axis range in place by typing directly into a portion of the axis displayed in the web browser 250. In this example, the user has selected the portion of the axis representing the upper limit of the X-axis range, which has the numeric value “50”. In FIG. 10, the user changes this value to “25” instead of “50”. FIG. 11 illustrates the graph after it has been re-displayed by the scripting code, based on the second information received from the web server computer system 90. The graph now illustrates data with an upper limit of “25” for the X-coordinate.

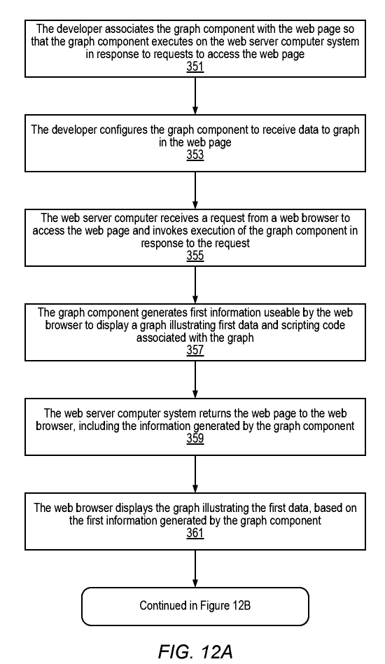

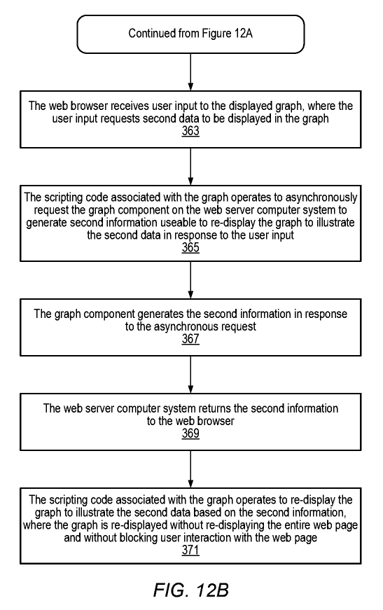

FIGS. 12A and 12B

In various embodiments of the web application, a developer may configure the web server computer system 90 in any of various ways in order to implement the above-described functionality of generating the information useable to display the graph in the web browser and generating the information useable to re-display the graph in response to the user interacting with the graph. In one embodiment the developer's task may be simplified by providing the developer with a re-usable software component that is pre-configured to implement this functionality. FIGS. 12A-12B illustrate one embodiment of a method for utilizing a re-useable software component for graphing data in web applications. This re-useable software component is referred to below as a “graph component”.

In 351, the developer associates the graph component with the web page 260 so that the graph component executes on the web server computer system 90 in response to requests to access the web page 260. In other words, the developer includes the graph component in the server-side web application software 248 on the web server computer system 90 so that the graph component executes in response to requests to access the web page 260.

In one embodiment, the graph component may be provided to the developer as a re-usable software component in a software development kit. In various embodiments, the graph component may be any of various types of re-useable software components and may be included in the server-side web application software 248 using various techniques, e.g., depending on which application development environment is used to create the server-side execution code. Examples of re-useable software components include ASP.NET controls and JavaBean components. An exemplary ASP.NET implementation of the graph component is described below.

In 353, the developer configures the graph component to receive the data to graph in the web page 260. In one embodiment the developer may not need to write program code to configure the graph component to receive the data to graph. For example, the developer may simply configure the graph component with a reference identifying a data source, and the graph component may be operable to automatically connect to the data source to receive the data from the data source, e.g., using data binding techniques. In another embodiment the developer may write program code to enable the graph component to connect to the data source to receive the data to be graphed. For example, the developer may write program code to implement one or more methods defined by an interface of the graph component, where the one or more methods operate to connect to the data source.

In one embodiment, configuring the graph component to receive the data to graph may comprise configuring the graph component to receive measurement data from a measurement application, such as the measurement application 240 executing on the computer system 92 connected to the web server computer system 90.

After the developer has configured the graph component in the server-side web application software 248, the web server computer 90 may then receive a request from the web browser 250 to access the web page 260, as indicated in 355. As described above, the web server computer 90 is configured to invoke execution of the graph component in response to this request, e.g., by calling a function or method of the graph component.

In 357, the graph component executes to receive first data from the data source configured in 353 and automatically generates first information useable by the web browser 250 to display a graph illustrating the first data. For example, in one embodiment the graph component may dynamically generate an image of the graph illustrating the first data, as well as HTML code for causing the web browser 250 to display the image, similarly as described above with reference to the flowchart of FIG. 5. The graph component also automatically generates the scripting code associated with the graph.

In 359, the web server computer system 90 returns the web page 260 to the web browser 250. Returning the web page 260 includes returning the information generated by the graph component in 357.

In 361, the web browser 250 displays the graph illustrating the first data, based on the first information generated by the graph component, similarly as described above with reference to block 305 of FIG. 5.

In 363, the web browser receives user input to the displayed graph, where the user input requests second data to be displayed in the graph, similarly as described above with reference to block 307 of FIG. 5.

In 365, the scripting code associated with the graph operates to asynchronously request the graph component on the web server computer system to generate second information useable to re-display the graph to illustrate the second data in response to the user input, similarly as described above with reference to block 309 of FIG. 5.

In 367, the graph component executes to generate the second information in response to the asynchronous request. For example, the web server computer 90 may be configured to invoke execution of the graph component in response to the asynchronous request, e.g., by calling a function or method of the graph component. In various embodiments, generating the second information may comprise generating any of various kinds of information useable by the scripting code associated with the graph to re-display the graph to illustrate the second data requested by the user input in 363. For example, the second information may comprise information useable to re-display the graph in response to the user requesting to zoom in to view a subset of data at a larger scale or requesting to change an axis range of the graph, similarly as described above.

In 369, the web server computer system 90 returns the second information to the web browser 250.

In 371, the scripting code associated with the graph operates to re-display the graph to illustrate the second data based on the second information. As described above, the graph is preferably re-displayed without re-displaying the entire web page 260 and without blocking user interaction with the web page 260.

It is noted that the graph component may be pre-configured to automatically perform the functionality of generating the first information that is useable by the web browser 250 to display the graph illustrating the first data. In other words, the developer may not need to write program code to generate the first information for displaying the graph because the graph component is already operable to perform this functionality.

The graph component may also be pre-configured to automatically perform the functionality of generating the scripting code associated with the graph. Thus, the developer may not need to write program code to generate the scripting code associated with the graph in the web browser because the graph component is already operable to perform this functionality. The automatically generated scripting code enables the user to interact with the graph displayed in the web browser 250 in various ways and operates to re-display the graph as appropriate in response to the user's actions.

The graph component may also be pre-configured to automatically perform the functionality of generating the second information that is useable to re-display the graph in response to the user's actions.

Thus, through the use of a re-useable graph software component, the method of FIGS. 12A and 12B may enable the developer to easily configure the web application to display an interactive data graph in the web browser 250. The developer simply includes the graph component in the server-side web application software 248 on the web server computer system 90 and configures the graph component as described above. The developer may simply need to write a small amount of simple program code to enable the graph component to properly interface with other portions of the server-side web application software 248 or may not need to write any program code at all.

In one embodiment the graph component may be provided to the developer by a third party. For example, a software vendor may package the graph component as an ASP.NET control or other type of re-useable software component for use by web application developers. Developers who wish to use the graph component in their web applications in order to automatically display interactive data graphs in client-side web browsers may install the graph component into their application development environment, thus making the graph component available for inclusion in the server-side web application software 248 on their web server computer system 90.

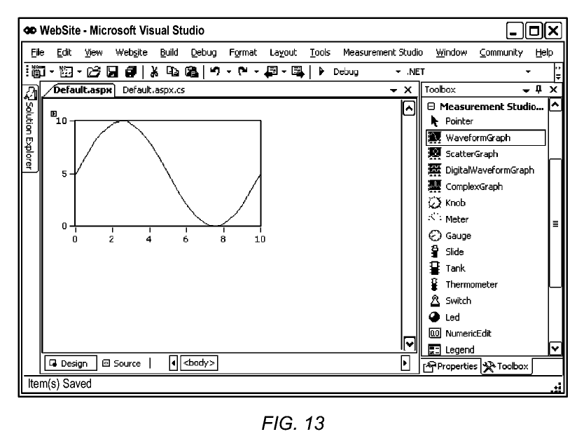

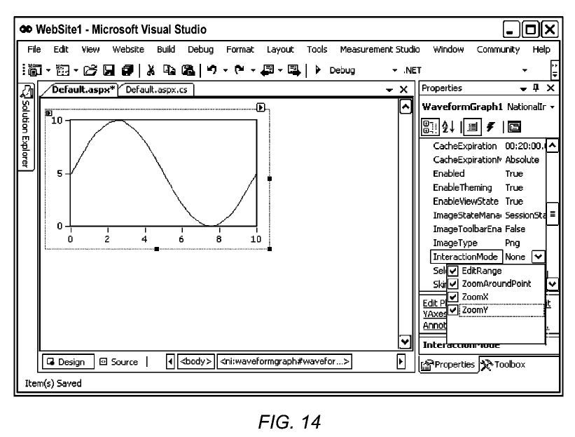

FIGS. 13 and 14 illustrate the use of an exemplary graph component in a web application, wherein the graph component is implemented as an ASP.NET control. In this example, the Microsoft Visual Studio application development environment is used to develop the server-side web application software 248 that executes on the web server computer system 90. In FIG. 13, the “Toolbox” pane on the right side of the window lists a plurality of ASP.NET controls available for inclusion in the server-side web application software 248, including the four ASP.NET controls named “WaveformGraph”, “ScatterGraph”, DigitalWaveformGraph”, and “ComplexGraph”. Each of these four ASP.NET controls represents a graph component for displaying a respective type of graph. The “WaveformGraph” control is used to display graphs illustrating waveform data. The “ScatterGraph” control is used to display graphs illustrating scatter points. The “DigitalWaveformGraph” control is used to display graphs illustrating digital waveforms. The “ComplexGraph” control is used to display graphs illustrating complex numeric data. Thus, the developer may include in the server-side web application software 248 whichever of these four ASP.NET controls is appropriate for illustrating the data to be graphed.

In this example, the developer has included an instance of the “WaveformGraph” control in the server-side web application software 248. For example, the developer may simply select the “WaveformGraph” control from the Visual Studio “Toolbox” pane with a pointing device, and then drag and drop the “WaveformGraph” control into the Visual Studio ASP.NET web form designer, i.e. the left-hand side portion of the window. Dropping the “WaveformGraph” control into the ASP.NET web form designer may associate the “WaveformGraph” control with a particular web page of the web application.

In response to the developer dropping the “WaveformGraph” control into the ASP.NET web form designer, a waveform graph is illustrated in the ASP.NET web form designer. This gives the developer a visual indication of how the waveform graph will appear in the web browser 250 on the client computer system.

The developer then configures various properties of the “WaveformGraph” control using its property panel. For example, FIG. 14 illustrates the “WaveformGraph” control's property panel on the right-hand side of the window. In this example, the developer selects which interactive behaviors supported by the “WaveformGraph” control he wants to be enabled. For example, as described above, the “WaveformGraph” control may be operable to generate scripting code that allows the end-user of the web browser to perform such actions as zooming in to a particular data region, interactively editing axis ranges of the graph, etc. The property panel of FIG. 14 allows the developer to selectively enable or disable these capabilities. In this example, the developer has enabled all of the interactive features supported by the “WaveformGraph” control by checking all four of the respective check boxes labeled, “EditRange”, “ZoomAroundPoint”, “ZoomX”, and “ZoomY”.

As described above with reference to block 353 of FIG. 12A, the developer may also configure the “WaveformGraph” control to receive the data to be graphed in the web browser 250, e.g., by specifying a reference to which the “WaveformGraph” control can connect through ASP.NET data binding techniques.

Once the “WaveformGraph” control has been dropped into the ASP.NET web form designer and configured using its property panel, the “WaveformGraph” control may be operable to automatically cause the data to be graphed in the web browser when the web browser accesses the corresponding web page. Thus, configuring the “WaveformGraph” control to graph the data in the web browser may require the developer to write little or no program code.

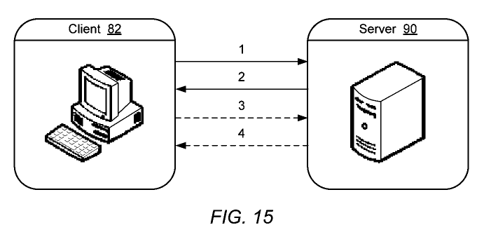

FIG. 15 is a diagram illustrating an overview of communication between the client computer system 82 and the web server computer system 90, according to one embodiment.

As indicated by arrow 1, the web browser 250 on the client 82 issues an HTTP request to the server 90 for the web page 260.

As indicated by arrow 2, the server 90 processes the HTTP request and sends an HTTP response back to the client 82 with the requested web page 260. As described above, in one embodiment this may involve the server 90 executing a graph component which generates at least a portion of the web page 260, including information for displaying a graph in the web page and Javascript code (or other scripting code) associated with the graph.

Upon receiving the web page 260, the client 82 displays the web page 260, including the graph. The user may then perform an action that requires the graph to be re-displayed, e.g., by selecting a region of the graph to zoom in to or interactively editing an axis range of one of the graph's axes. In response, the Javascript code associated with the graph may issue an asynchronous request, e.g., an XMLHTTP request, to the server 90, as indicated by arrow 3. The asynchronous request may include information that describes the action performed by the user.

The server 90 processes the XMLHTTP request and generates update information useable to re-display the graph in the web browser in order to reflect the action performed by the user. As described above, in one embodiment the server 90 may execute the graph component in response to the XMLHTTP request, where the graph component generates the information for re-displaying the graph. As indicated by arrow 4, the server 90 returns the generated update information to the client 82. The server 90 may also save state information indicating what information was returned to the client 82. Thus, the server 90 may know the state of the graph illustrated in the web browser, such as the current axis ranges for the graph.

As described above, upon receiving the update information, the JavaScript code on the client 82 processes the update information to re-display the graph to reflect the action performed by the user.

Simultaneously Re-Displaying a Plurality of User Interface Elements in a Web Browser

In addition to graph user interface elements such as described above, various other kinds of user interface elements may be displayed in a web page, where the user interface elements can have any of various appearances and display various kinds of data. In many web applications it is necessary to periodically refresh (re-display) a plurality of user interface elements displayed in a web page in a web browser.

For example, consider a web application that enables a user to remotely monitor a measurement application via a web browser. The web browser may display a web page including a plurality of user interface elements for monitoring the measurement application. For example, a first user interface element may display a first measurement signal or measurement variable acquired by the measurement application, a second user interface element may display a second measurement signal or measurement variable acquired by the measurement application, etc. Thus, it may be necessary to periodically re-display the user interface elements so that each user interface element displays the current value(s) for its respective measurement signal or variable.

In many applications it would be desirable to enable all of the user interface elements to be re-displayed simultaneously. For example, consider a web application that displays temperature and pressure data acquired by a measurement application. The temperature may be displayed in one user interface element, and the pressure may be displayed in another user interface element. These two user interface elements may be periodically refreshed so that they indicate the current temperature and pressure. It may be desirable to update both of the user interface elements in such a way that the user sees them both re-displayed at the same time. For example, the web application may be designed to display a temperature value and pressure value that were both acquired at the same time and together indicate a current state of the system under test. Thus, re-displaying both user interface elements at the same time may ensure that the temperature value that is displayed by the first user interface element always corresponds to the pressure value that is displayed by the second user interface element.

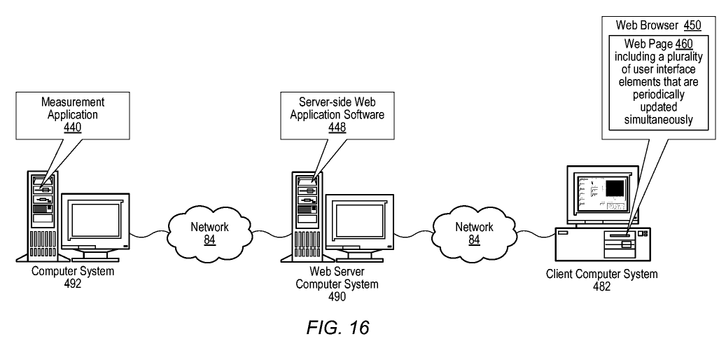

FIG. 16 illustrates one embodiment of a system that implements a web application operable to simultaneously refresh a plurality of user interface elements displayed in a web page of a web browser. The system of FIG. 16 includes similar elements as the system of FIG. 1 described above, such as a client computer system 482 coupled to a web server computer system 490 by a network 84.

The client computer system 482 and the web server computer system 490 may operate together to implement a method for periodically updating or re-displaying a plurality of user interface elements displayed on the display device of the client computer system 82, where the plurality of user interface elements are re-displayed simultaneously. More particularly, the client computer system 482 executes a web browser software program 450. The web browser 450 requests a web page 460 from the web server computer system 490. In response to the request for the web page 460, the web server computer system 490 executes server-side web application software 448 in order to retrieve or generate the web page 460, and the web server computer system 490 returns the web page 460 to the client computer system 482.

The web page 460 returned to the client computer system 482 includes first information useable by the web browser 450 to display a plurality of user interface elements on the display device of the client computer system 482. The web page 460 also includes scripting code associated with the plurality of user interface elements displayed in the web page 460. The scripting code associated with the user interface elements may be operable to periodically communicate with the web server computer system 490 in order to receive update information useable to re-display the plurality of user interface elements. The scripting code preferably re-displays the user interface elements in such a way that they appear to the web browser user to be re-displayed simultaneously. One embodiment of a method for initially displaying the user interface elements in the web browser 450 and subsequently re-displaying the user interface elements in a simultaneous fashion is described in more detail below.

In one embodiment the server-side web application software 448 may utilize various re-useable software components for displaying the user interface elements in the web browser and generating update information for re-displaying the user interface elements. The re-useable software components may enable a developer to easily configure the web application to periodically perform the simultaneous re-display functionality described herein. Exemplary re-useable software components that may be utilized are described below.

As noted above, in one embodiment, one or more of the user interface elements displayed in the web page 460 may display measurement data. In the exemplary system illustrated in FIG. 16, the web server computer system 490 is coupled to another computer system 492 by a network 84. The computer system 492 may execute measurement application software 440, e.g., in order to interact with or control one or more measurement devices to acquire measurement data from a physical system or unit under test. The server-side web application software 448 executing on the web server computer system 490 may communicate with the measurement application software 440 executing on the computer system 92 in order to receive measurement data to be displayed in one or more of the user interface elements in the web page 460 on the client computer system 482.

In many prior art web applications, updating a web page that includes a plurality of user interface elements involves the web browser synchronously communicating with the web server in order to receive an updated version of the web page. The entire web page may then be refreshed (re-displayed) in the web browser, using the updated version of the web page. During the time that the web browser is synchronously communicating with the web server to receive the updated version of the web page, the user may be blocked from interacting with the web page. Also, when the web page is refreshed, the web browser window may be momentarily cleared and then re-displayed using the updated version of the web page. Thus, the user sees the web browser window momentarily go blank before re-appearing. The result is that the user experiences his interaction with the web application as being somewhat awkward.

Also, in many prior art web applications that involve refreshing or re-displaying a plurality of user interface elements in a web browser, the re-display of the user interface elements is not controlled in order to ensure that they are all re-displayed simultaneously. For example, the user may notice a slight delay between the time when one user interface element is re-displayed and the time when another user interface element is re-displayed. Again, this delay in the re-display times may seem somewhat awkward. Furthermore, the user interface elements may temporarily be out of sync with each other with respect to the data that each one displays.

In contrast to these prior art web applications, the method described herein may involve the scripting code associated with the user interface elements communicating asynchronously with the web server computer system 490 to receive the update information useable for re-displaying the plurality of user interface elements. By performing the communication asynchronously, the user's interaction with the web page 460 may not be blocked while the update information is being requested. The scripting code associated with the user interface elements may also be operable to control the re-display of the user interface elements so that they are re-displayed simultaneously and without causing the entire web page to be re-displayed.

In the preferred embodiment, the web page 460 does not require the web browser 450 to have any plug-in software installed in order to achieve this type of re-display of the user interface elements. In other words, the web page 460 includes only elements understood by (i.e., able to be processed by) a standard web browser and does not include elements not understood by a standard web browser. For example, the web page 460 may comprise elements understood by standard web browsers, such as markup language code, scripting code, and images. In one embodiment, the web page 460 comprises HTML code, Javascript code, and images. The Javascript code may comprise the scripting code associated with the user interface elements and may periodically asynchronously communicate with the web server computer system 490 to re-display the user interface elements.

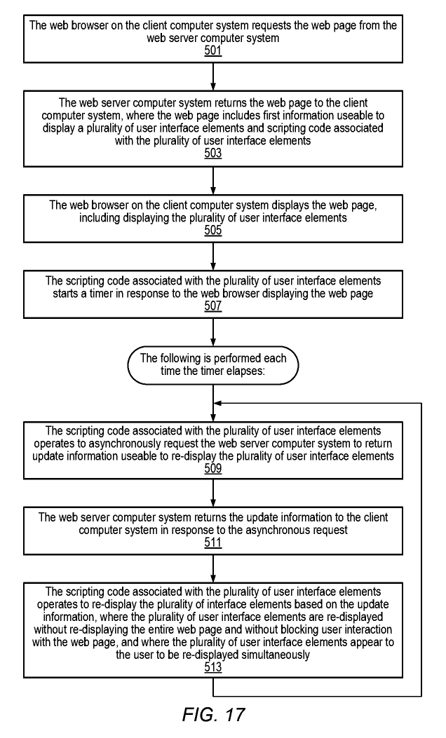

FIG. 17—Method for Re-Displaying a Plurality of User Interface Elements in a Web Browser

Referring now to FIG. 17, a flowchart diagram illustrating one embodiment of a method for periodically re-displaying a plurality of user interface elements in a web browser in a simultaneous fashion is shown. It is noted that FIG. 17 illustrates a representative embodiment, and alternative embodiments are contemplated. Also, various elements may be combined, omitted, or performed in different orders.

In 501 the web browser 450 on the client computer system 482 requests the web page 460 from the web server computer system 490, e.g., by performing an HTTP request referencing a URL of the web page 460.

In 503, the web server computer system 490 returns the web page 460 to the client computer system 482. The web page 460 includes first information useable by the web browser 450 to display a plurality of user interface elements. As used herein, the term “user interface element” refers to a graphical element displayed in a window, where the graphical element is operable to display data and/or receive user input. User interface elements are also sometimes referred to as user interface controls or user interface indicators. Examples of user interface elements commonly used include buttons, text boxes, list boxes, numeric controls, check boxes, etc. User interface elements may also be specialized for displaying a particular kind of data or may be specialized for use in particular types of applications. For example, user interface elements useful for measurement applications include a graph for plotting numeric data, a thermometer indicator for indicating temperature data, an LED indicator, a meter indicator, a tank indicator indicating the level of a tank, etc.

In various embodiments the first information may comprise information of any kind which the web browser 450 can use to display the user interface elements. However, the first information preferably does not include information that is not understood by a standard web browser. In one embodiment the first information may be limited to including only markup language code (e.g., HTML code), images, and/or scripting code (e.g., Javascript code). In one embodiment, the first information may include markup language code, e.g., HTML code, where the markup language code includes one or more tags specifying one or more of the user interface elements to be displayed by the web browser 450. For example, the HTML markup language includes an <INPUT> tag for displaying an input field user interface element. In another embodiment, one or more of the user interface elements may be represented as images. For example, a user interface element may be displayed in the web browser 450 by displaying an image, such as a JPG image, GIF image, or other type of image, or may be displayed by displaying a combination of images that together illustrate the user interface element. Thus, the first information may include the images that represent the user interface elements, as well as markup language code (e.g., <IMG> tags) that cause the images to be displayed by the web browser 450.

In various embodiments, the web page 460 returned to the client computer system 482 may include first information useable to display any of various kinds of user interface elements. In one embodiment, one or more of the user interface elements may be operable to display measurement data acquired from a measurement device. As one example, a user interface element may comprise an image of a graph, where the graph illustrates the measurement data. For example, the graph may comprise a waveform graph that illustrates waveform measurement data. As another example, a user interface element may comprise an image of a meter, where the meter illustrates a numeric value acquired by a measurement device coupled to a physical system or unit under test.

The web page 460 returned to the client computer system 482 also includes scripting code associated with the plurality of user interface elements. In one embodiment the scripting code comprises Javascript code. The scripting code operates as described below.

In 505, the web browser 450 on the client computer system 482 displays the web page 460. Displaying the web page 460 includes displaying the plurality of user interface elements, based on the first information. For example, where a user interface element comprises an image, displaying the web page 460 includes displaying the image of the user interface element.

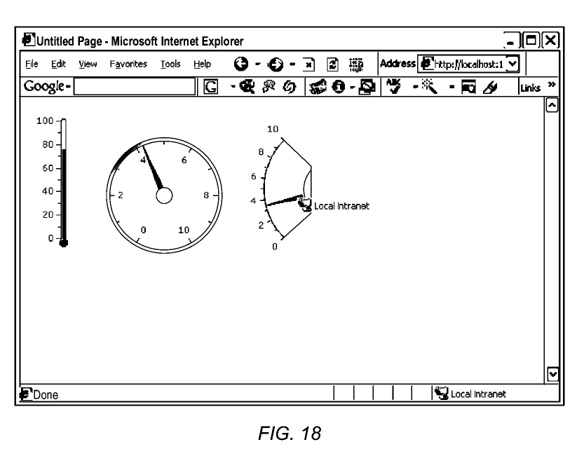

FIG. 18 illustrates one example of three user interface elements displayed in a web browser 450. The user interface element on the left illustrates a thermometer, which displays a current temperature value of approximately 75 degrees. The user interface element in the middle illustrates a gauge, which displays a current measurement data value of approximately 4.2. The user interface element on the right illustrates a meter, which displays a current measurement data value of approximately 3.4. In other embodiments, any of various other types of user interface elements illustrating measurement data or other kinds of data may be displayed in the web page 460.

The method of FIG. 17 further comprises the web browser 450 starting a timer after displaying the web page 460, where the timer is set to elapse after a certain amount of time. In one embodiment the scripting code associated with the user interface elements may start the timer in response to the web browser 450 displaying the web page 460. The elapsing of the timer indicates that it is time to re-display the plurality of user interface elements. Blocks 509, 511, and 513 may be performed in response to the timer elapsing.

In 509, the scripting code associated with the plurality of user interface elements operates to asynchronously request the web server computer system 490 to return update information useable to re-display the plurality of user interface elements. In one embodiment this asynchronous request may be performed as an XMLHTTP request.

In 511, the server-side web application software 448 on the web server computer system 490 executes to generate or retrieve the update information in response to the asynchronous request, and the web server computer system 490 returns the update information to the client computer system 482. Generating the update information may comprise generating update information for each of the user interface elements, where the update information for each user interface element is useable to re-display the user interface element in the web browser 450. For example, for each user interface element, the server-side web application software 448 may determine what data the user interface element should currently display and may then generate update information useable to re-display the user interface element so that it displays the correct data. If the user interface element is displayed as an image in the web browser then the server-side web application software 448 may generate a new image for the user interface element, e.g., where the new image illustrates the correct data.

In 513, the scripting code associated with the plurality of user interface elements operates to re-display the plurality of interface elements based on the update information. For example, if a particular user interface element is displayed as an image then the scripting code may cause the image to be replaced with a new image specified by the update information. In the preferred embodiment the plurality of user interface elements are re-displayed simultaneously (or re-displayed in such a way that they appear to the user to be re-displayed exactly simultaneously). For example, if a plurality of new images representing different user interface elements need to be displayed then the scripting code may first download each of the images. When all of the new images have been received, the scripting code may then display all of the images, replacing the previously displayed images.

The user interface elements are preferably re-displayed without re-displaying the entire web page, e.g., without re-displaying elements of the web page other than the images or other elements that represent the user interface elements. For example, the scripting code may utilize a Document Object Model supported by the web browser to cause only the user interface elements to be re-displayed.

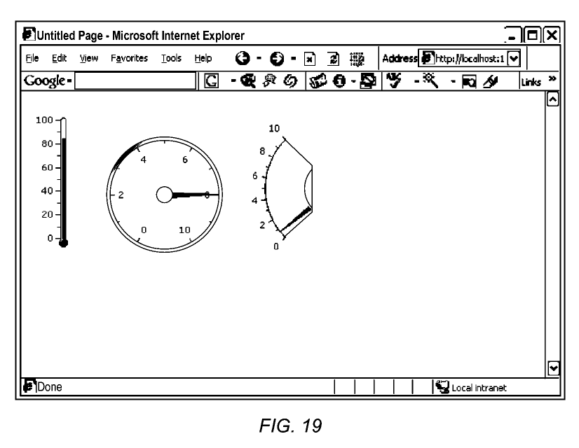

FIG. 19 illustrates an example in which the three user interface elements shown in FIG. 18 have been re-displayed. The thermometer user interface element now displays a temperature value of approximately 84 degrees. The gauge user interface, element now displays a measurement data value of approximately 8.0. The meter user interface element now displays a measurement data value of approximately 0.9. All three of the data values displayed by the three user interface elements appear to the user to change simultaneously from the values shown in FIG. 18 to the values shown in FIG. 19.

In one embodiment the timer in the web browser 250 may repeatedly elapse. Each time the timer elapses, blocks 509, 511, and 513 may be performed in order to cause the plurality of user interface elements to be simultaneously re-displayed in the web browser 450.

In one embodiment the timer may repeatedly elapse at regular time intervals. Thus, the plurality of user interface elements may be simultaneously refreshed at regular time intervals. The maximum refresh rate may depend on the network latency characteristics of the network 84 connecting the client computer system 482 to the web server computer system 490. On some types of networks, such as an Intranet, it may be possible to have a refresh rate as fast as four or five times per second, or even faster, with little or no noticeable jitter.

Thus, the method of FIG. 17 may enable the user interface elements to be re-displayed in the web browser at a fixed rate, where the user interface element are re-displayed simultaneously and without causing the web browser window to flash or temporarily go blank or exhibit other characteristics that seem awkward to the user.

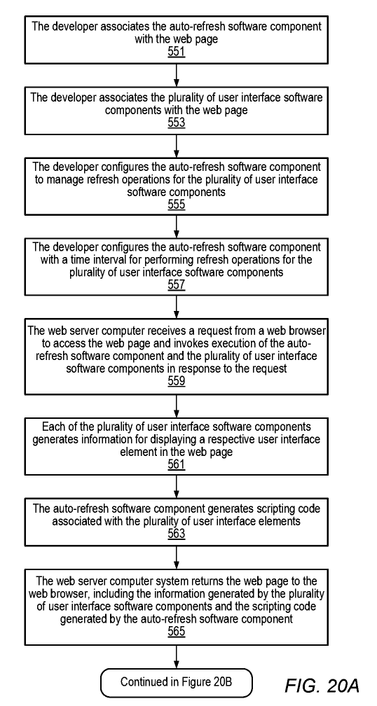

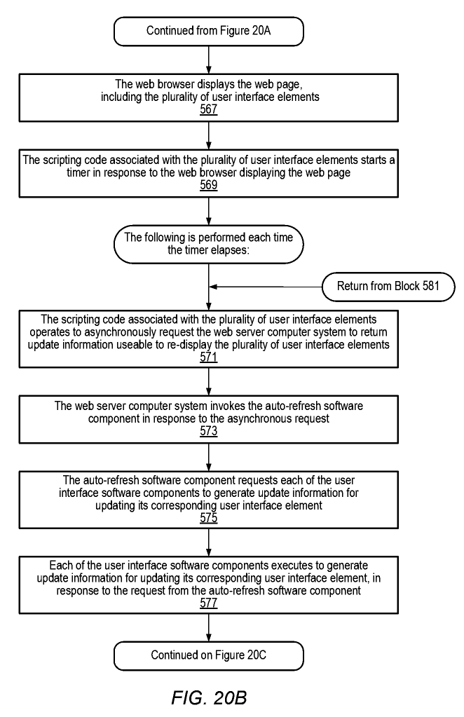

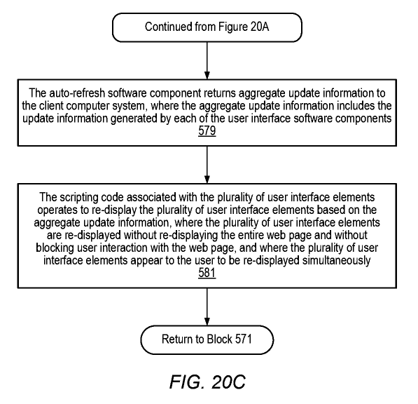

FIGS. 20A-20C

In various embodiments, a developer may configure the web server computer system 490 in any of various ways in order to implement the above-described functionality of generating the first information useable to display the plurality of user interface elements in the web browser 450 and generating the update information for the user interface elements in response to the asynchronous requests from the scripting code. In one embodiment the developer's task may be simplified by providing the developer with re-usable software components that are pre-configured to implement this functionality. FIGS. 20A-20C illustrate one embodiment of a method for utilizing various re-useable software components for periodically refreshing user interface elements in web applications.

In particular, the method involves the use of a plurality of user interface software components on the web server computer system 490, where each user interface software component corresponds to one of the user interface elements displayed in the web browser on the client computer system. The method also involves the use of a re-useable software component which interfaces with the plurality of user interface software components in order to manage the updates of the user interface elements displayed in the web browser. This re-useable software component is referred to below as an auto-refresh software component.

In 551, the developer associates the auto-refresh software component with the web page 460, e.g., so that the auto-refresh software component executes on the web server computer system 490 in response to requests to access the web page 460. In other words, the developer includes the auto-refresh software component in the server-side web application software 448 on the web server computer system 490 so that the auto-refresh software component executes in response to requests to access the web page 460.

In one embodiment, the auto-refresh software component may be provided to the developer as a re-usable software component in a software development kit. In various embodiments, the auto-refresh software component may be any of various types of re-useable software components and may be included in the server-side web application software 448 using various techniques, e.g., depending on which application development environment is used to create the server-side execution code. An exemplary ASP.NET implementation of the auto-refresh software component is described below.

In 553, the developer associates the plurality of user interface software components with the web page 460. For example, the developer may include the user interface software components in the server-side web application software 448 on the web server computer system 490 so that they execute in response to requests to access the web page 460. (As described below, in one embodiment the auto-refresh software component may invoke execution of the user interface software components.)

Each of the user interface software components represents one of the user interface elements to be displayed in the web page 460. As described below, when the web browser 450 initially requests the web page 460, each user interface software component may execute to generate information for displaying the corresponding user interface element in the web browser 450. The user interface software components may also be operable to generate the update information for re-displaying their respective user interface elements.

In one embodiment, associating a user interface software component with the web page 460 may comprise configuring the user interface software component to receive the data to be displayed in the corresponding user interface element in the web browser 450, e.g., by configuring the user interface software component with a reference useable to automatically connect to a data source to automatically receive the data, e.g., using data binding techniques, or by writing program code to enable the user interface software component to connect to the data source.

In one embodiment, configuring a user interface software component to receive data to display may comprise configuring the user interface software component to receive measurement data from a measurement application, such as the measurement application 440 executing on the computer system 492 connected to the web server computer system 490.

In 555, the developer may configure the auto-refresh software component to manage refresh operations (i.e., update operations) for the plurality of user interface software components. This may involve configuring the auto-refresh software component to interface with the user interface software components, e.g., to invoke their execution in response to requests from the web browser 450, as described below.

In one embodiment the developer does not need to write program code in order to configure the auto-refresh software component to manage refresh operations for the plurality of user interface software components. For example, the developer may simply select the user interface software components to be associated with the auto-refresh software component, e.g., by interacting with a property panel of the auto-refresh software component.

As described above, in one embodiment the user interface elements in the web browser may be periodically re-displayed according to a fixed time interval. Thus, as shown in 557, the developer may configure the auto-refresh software component with a time interval for performing the refresh operations for the plurality of user interface software components.

After the developer has configured the auto-refresh software component and the user interface software components in the server-side web application software 448, the web server computer 490 may then receive a request from the web browser 450 to access the web page 460, as indicated in 559. In response to this request, the web server computer 490 may invoke execution of the auto-refresh software component and the user interface software components. In one embodiment the web server computer may invoke execution of the auto-refresh software component, which in turn invokes execution of the user interface software components.

As indicated in 561, each of the plurality of user interface software components executes to generate information for displaying a respective user interface element in the web page 460. For example, as described above with reference to FIG. 17, this may involve generating information for displaying an image of the user interface element or generating various other types of information useable to display the user interface element in the web page 460.

As indicated in 563, the auto-refresh software component executes to generate the scripting code associated with the plurality of user interface elements, where the scripting code operates as described above with reference to FIG. 17.

In 565, the web server computer system 490 returns the web page 460 to the web browser 450, including the information generated by the plurality of user interface software components and the scripting code generated by the auto-refresh software component.

In 567, the web browser displays the web page 460. Displaying the web page 460 includes displaying the plurality of user interface elements, based on the display information generated by the corresponding user interface software components in 561.

In 569, the scripting code associated with the user interface elements starts a timer in response to the web browser 450 displaying the web page 460. As discussed above, the timer may periodically elapse according to a regular time interval, i.e., the time interval specified by the 557. In other words, the developer configuring the auto-refresh software component with the time interval in 557 may comprise configuring the auto-refresh software component to generate the scripting code in such a way that the timer set by the scripting code elapses according to the time interval.

Each time the timer elapses, the scripting code associated with the plurality of user interface elements may operate to asynchronously request the web server computer system 490 to return update information useable to re-display the plurality of user interface elements, as indicated in 571.

In response to the asynchronous request, the web server computer system 490 invokes the auto-refresh software component, as indicated in 573. In 575, the auto-refresh software component may execute to request each of the user interface software components to generate update information for updating its corresponding user interface element. In 577, each of the user interface software components executes to generate update information for updating its corresponding user interface element, in response to the request from the auto-refresh software component. This may comprise each user interface software component receiving data from the data source with which the user interface software component is associated, i.e., receiving the data which the respective user interface element should illustrate when it is re-displayed in the web page 460. The update information generated by each user interface software component may comprise a new image or other information for re-displaying the corresponding user interface element in the web page 460, as discussed above.

In 579, the auto-refresh software component returns may aggregate the update information generated by each of the user interface software components and return the aggregate update information to the client computer system 482.

In 581, the scripting code associated with the plurality of user interface elements may operate to re-display the plurality of user interface elements based on the aggregate update information. As discussed above, the plurality of user interface elements may be re-displayed without re-displaying the entire web page and without blocking user interaction with the web page. The plurality of user interface elements may also be re-displayed in such a way that they appear to the user to be re-displayed simultaneously.

It is noted that the auto-refresh software component may be pre-configured to automatically perform the functionality described above of managing the re-display of the user interface elements displayed in the web page 460. Each of the user interface software components may implement an interface which the auto-refresh software component utilizes to communicate with the user interface software components. The auto-refresh software component may simply call methods defined by this interface in order to request them to generate their respective update information. Thus, the auto-refresh software component may be utilized to manage any of various kinds of user interface software components, provided that they implement this interface. The auto-refresh software component may be operable to automatically interface with the user interface software components in response to the update requests received from the scripting code in the web browser 450. In other words, the developer may not need to write program code to implement this functionality because the auto-refresh software component is already operable to perform this functionality.

The auto-refresh software component may also be pre-configured to automatically perform the functionality of generating the scripting code associated with the user interface elements in the web browser 450. Thus, the developer may not need to write program code to generate the scripting code associated with the user interface elements because the auto-refresh software component is already operable to perform this functionality. The automatically generated scripting, code operates to periodically communicate with the web server computer system 490 to cause the user interface elements to be automatically re-displayed.

Similarly, the user interface software components may be pre-configured to automatically perform the functionality of generating the first information to initially display their corresponding user interface elements in the web browser 450 and to generate the respective update information for the user interface elements in response to each update request received from the client computer system 482.

Thus, through the use of the re-useable user interface software components and the re-useable auto-refresh software component, the method of FIGS. 20A-20C may enable the developer to easily configure the web application to cause a plurality of user interface elements to be periodically refreshed in the web browser 450. The developer simply includes the auto-refresh software component and the user interface software components in the server-side web application software 448 on the web server computer system 490 and configures them as described above.

In one embodiment the auto-refresh software component and the user interface software components may be provided to the developer by a third party. For example, a software vendor may package these component as ASP.NET controls or another other type of re-useable software component for use by web application developers. Developers who wish to use the components in their web applications in order to automatically cause a plurality of user interface elements to be displayed and periodically refreshed in client-side web browsers may install the components into their application development environment, thus making the components available for inclusion in the server-side web application software 448 on their web server computer system 490.

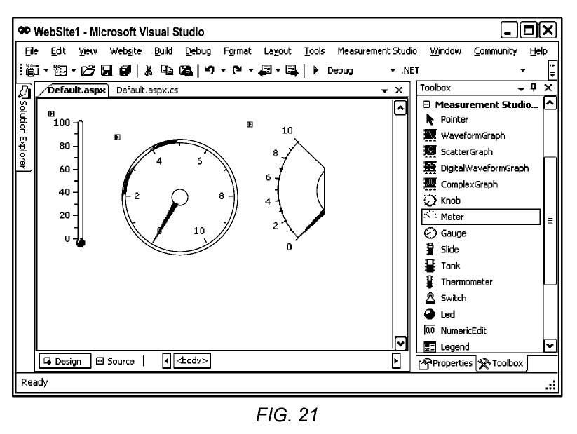

FIGS. 21-27 illustrate the use of an exemplary auto-refresh software component and exemplary user interface software components, where the components are implemented as ASP.NET controls. In this example, the Microsoft Visual Studio application development environment is used to develop the server-side web application software 448 that executes on the web server computer system 490.

The developer adds the user interface software components to the web page by dragging and dropping the desired ASP.NET user interface controls from the Visual Studio toolbox to the Visual Studio ASP.NET web form designer window. FIG. 21 illustrates three user interface elements corresponding to three ASP.NET controls that have been added to the web page.

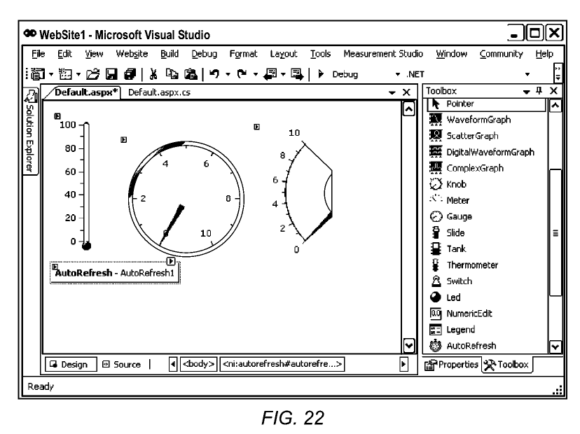

The developer also adds the auto-refresh software component to the web page by dragging and dropping the ASP.NET auto-refresh control from the Visual Studio toolbox to the Visual Studio ASP.NET web form designer. FIG. 22 illustrates the web form designer window after the user has added the ASP.NET auto-refresh control. (The ASP.NET auto-refresh control is visible in the web form designer window in FIG. 22 but will not be visible in the web page 460 displayed on the client computer 482.)

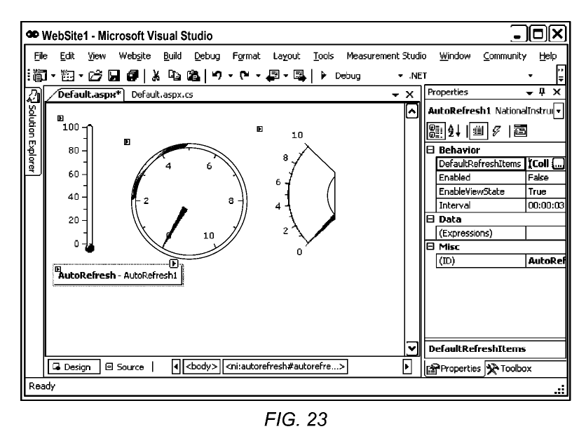

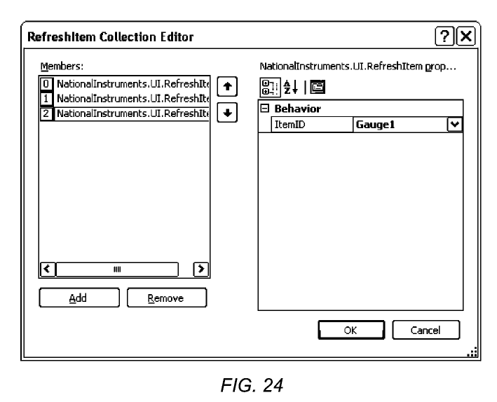

The developer then specifies that the three ASP.NET user interface controls are to be updated together on an interval by going to the “DefaultRefreshItems” property in the property panel for the auto-refresh control and adding the three ASP.NET user interface controls via the collection editor, as indicated in FIGS. 23 and 24.

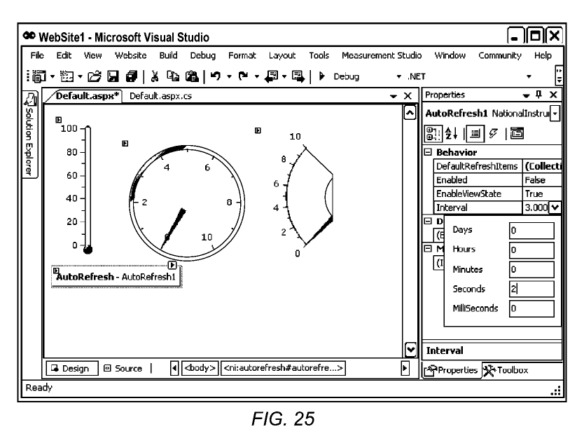

The developer then specifies the time interval for updating the controls by going to the “Interval” property in the property panel for the auto-refresh control and specifying the desired time interval, as indicated in FIG. 25.

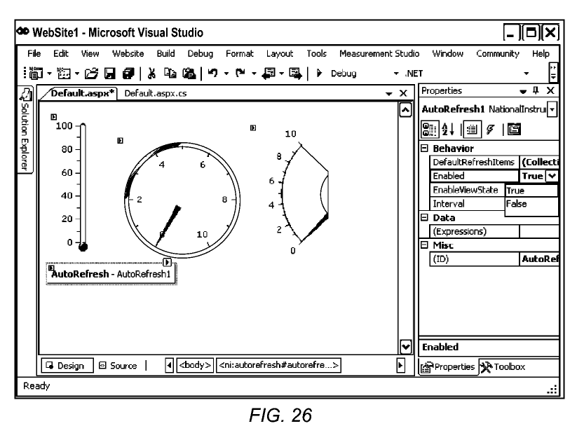

The developer then enables the auto-refresh functionality by going to the “Enabled” property in the property panel for the auto-refresh control and setting the property to True, as indicated in FIG. 26.

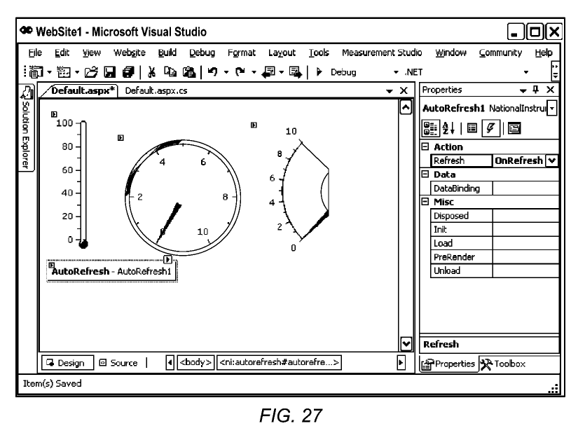

The developer then specifies the updates that must occur on the specified time interval by going to the “Refresh” event window and specifying an event handler, as indicated in FIG. 27. The developer may write the program code that executes when the specified time interval elapses.

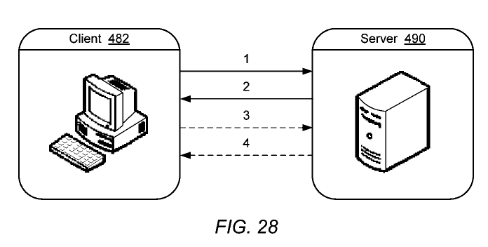

FIG. 28 is a diagram illustrating an overview of communication between the client computer system 482 and the web server computer system 490, according to one embodiment.

As indicated by arrow 1, the web browser 450 on the client 482 issues an HTTP request to the server 490 for the web page 460.

As indicated by arrow 2, the server 490 processes the HTTP request and sends an HTTP response back to the client 482 with the requested web page 460. As described above, in one embodiment this may involve the server 490 executing an auto-refresh software component which sends JavaScript code to the client 482 as part of this response. In one embodiment this may also involve the server 490 executing user interface software components that generate information for displaying corresponding user interface elements in the web page 460.

Upon receiving the web page 460, the client 482 displays the web page 460, including the plurality of user interface elements. The JavaScript code generated by the auto-refresh software component starts a timer on the client 482. When the timer elapses, the JavaScript code issues an asynchronous XMLHTTP request to the server 490, as indicated by arrow 3.

The server 490 processes the XMLHTTP request and raises a “Refresh” event on the server 490. In response to the “Refresh” event, the auto-refresh software component executes. The user interface software components associated with the auto-refresh software component are invoked by the auto-refresh software component, and they execute to generate update information for updating the respective user interface elements on the client 482. The auto-refresh software component creates a response that describes how to update the user interface elements and returns the response to the client 482, as indicated by arrow 4.

As described above, upon receiving the update information, the JavaScript code on the client 482 processes the update information to re-display the plurality of user interface elements.

Exemplary ASP.NET Controls

As discussed above, in one embodiment a re-useable graph component may be implemented as an ASP.NET control. Similarly, in one embodiment, a re-useable auto-refresh software component and re-useable user interface software components may be implemented as ASP.NET controls. The remainder of this disclosure provides further information regarding exemplary ASP.NET controls and also regarding exemplary Javascript code that may be used in the web browser in order to implement the methods described above.

It is noted that the description below refers to an exemplary embodiment that utilizes ASP.NET controls and does not limit the scope of the systems or methods described above, but rather provides further details regarding an exemplary embodiment. It is also noted that other embodiments that use ASP.NET controls are contemplated, and the described ASP.NET controls are intended to be exemplary only.

Graph Controls

ASP.NET controls referred to as Web Forms graphs may include a family of controls for graphing data, such as a WaveformGraph control, ScatterGraph control, and DigitalWaveformGraph control.

The Web Forms WaveformGraph and ScatterGraph controls provide the following client behavior and interaction features:

Interactive and animated zooming—The Web Forms graphs provide zooming functionality, such as zoom around point, rubber band selection zooms, alpha-blended selection highlights, and zoom animations.

Editable Axis Ranges

Client updates without a postback—The Web Forms graphs use XML HTTP requests via ASP.NET 2.0 client callbacks to perform graph updates without having to post back to the server.

There are two main resources that are sent to the client that drive the graph's client behavior and interaction:

Behavior XML data island—An XML data island is rendered to the client that contains information that is needed to drive behavior on the client. This information includes the plot area bounds coordinates, the zooming selection color, the interaction mode, etc. The XML data island also includes information about the axis ranges for interactive axis range editing, including the axis type, bounds, edit format value, font, etc.

GraphBehavior JavaScript object—Implements the graph's rich client behavior and interaction by handling several events of the <img/> element on the client, evaluating data in the behavior XML data island, and using client features to mimic Windows Forms interactions.

GraphBehavior is created as part of the page's startup scripts with a value that indicates the type of graph (XY or digital), the id of the <img/> element, and the id of the XML data island. GraphBehavior uses the behavior type parameter to determine if certain behavior should be included or excluded depending on the type of the graph. The only behavioral difference between the XY and digital graphs is if GraphBehavior will execute XML HTTP requests for mouse clicks that are outside of the plot area. GraphBehavior uses the <img/> element ID to obtain a reference to the image DOM element to install event handlers for several events (onmousedown, onmousemove, onmouseup, etc.) on the <img/> element. GraphBehavior uses the XML data island ID to obtain a reference to the XML DOM element and initialize itself from the data in the data island.

GraphBehavior uses a custom JavaScript object called Selector to provide rubber band selections and zoom animations. GraphBehavior initializes Selector with the following information:

Target element—The target element in the context of GraphBehavior is the <img/> element.

Selector style—The selector style is a bitmask value that can contain bits for horizontal and vertical styles. In the context of the graph, this maps to bitwise combinations of ZoomX and ZoomY. GraphBehavior performs this translation.

Context bounds—The bounds of the target element that Selector will operate in. In the context of the graph, this is the plot area bounds.

Selection color—The color of the selection border and selection area. The selection area is alpha-blended at 25% opacity.

Interaction cursor—Specifies the mouse cursor to use for interactions.

Selector dynamically creates three div elements for the rubber band selections:

Selection element—An empty div element with a 1-pixel border whose color is the specified selection color.

Alpha element—An empty div element whose background color is the specified selection color. The alpha element also uses a DX alpha filter to set the opacity of the div element to 25%.

Animation element—An empty div element with a 1-pixel border that is dynamically resized many times very quickly after the selection has been made for the zooming animation.

Selector also dynamically creates a container div element and reparents the target element in the container div, then also adds the three elements above as children of this container. The motivation for this container element is to provide a relative positioning context for the selection, alpha, and animation elements.

DHTML events are not multicasting and can only have one event handler at a time, so the <img/> mouse event handlers are provided by GraphBehavior and Selector provides methods that are called from GraphBehavior's mouse event handlers. The interaction flow for zoom selections is as follows:

omnousedown—GraphBehavior's onmousedown event handler first calls Selector.BeginSelection, which positions the selection elements and makes them visible. It then calls setCapture on the <img/> element so that mouse events are directed to the <img/> element if the user drags the mouse outside of the bounds of the <img/> element.

onmousemove—GraphBehavior's onmousemove event handler calls Selector.TrackSelection, which dynamically resizes the selection elements based on event data.

onlosecapture—The onlosecapture event could fire because the browser window loses focus or the user lets go of the mouse, in which case GraphBehavior's onmouseup event handler calls releaseCapture on the <img/> element. This event handler calls Selector.EndSelection, which saves the final selection coordinates and hides the selection div elements.

onmouseup—GraphBehavior's onmouseup event handler calls releaseCapture on the <img/> element and then calls Selector.ShowZoomAnimation, which resizes the animation element several times on a timer to create a zoom animation effect. GraphBehavior then calls Selector.GetSelectedBounds to actually process the selected bounds to perform a zoom operation.

GraphBehavior uses a custom JavaScript object called EditWindow to provide interactive axis range editing. GraphBehavior initializes EditWindow with the following information:

Target element—The target element in the context of GraphBehavior is the <img/> element.

Edit callback—A callback JavaScript function that will be called with the edited value when the user has finished editing the value.

EditWindow dynamically creates an <input type=“text”/> element for editing labels. EditWindow also dynamically creates a container div element and reparents the target element in the container div, then also adds the <input type=“text”/> element as a child of this container. The motivation for this container element is to provide a relative positioning context for the <input type=“text”/> element.

Similar to the Selector design, EditWindow provides methods that are called from GraphBehavior's event handlers. The interaction flow for editing axis range labels is as follows:

<img/> onmousedown—Graph's onmousedown event handler calls EditWindow.BeginEdit with the current value of the axis range label, the bounds of the label, and the font of the label. EditWindow.BeginEdit sets the value of the input type=“text”/> element, resizes the bounds of the <input type=“text”/> element to be the same size as the axis label, and sets the font of the <input type=“text”/> element to be the specified font. EditWindow.BeginEdit also sets the focus to the edit window and calls setCapture on the <input type=“text”/> element.

<input type=“text”/> onkeypress (not Enter or Escape)—The user types into the edit window, which fires the <input type=“text”/> element's onkeypress event. If the key that is pressed is not the Enter or Escape key, EditWindow uses a TextRange to determine the size of the edited value and dynamically resizes the edit window to be the maximum of this measured size and the original size. This provides the experience of automatically growing or shrinking the edit window, while at the same time ensuring that the label on the image is always covered, which would break the illusion that the label was being edited.

<input type=“text”/> onmousedown, onblur, and onkeypress (Enter or Escape)—The <input type=“text”/> element's onmousedown event will fire if the user clicks on the document since it has the mouse capture and the onblur event will fire if it loses focus. In both of these cases, the event handlers will call EditWindow.EndEdit with true. The onkeypress event handler checks if the key that was pressed was the Enter key and if so, calls EditWindow.EndEdit with true and cancels the event. The onkeypress event handler also checks if the key that was pressed was the Escape key and if so, calls EditWindow.EndEdit with false. The parameter to EditWindow.EndEdit indicates if the value should be committed. EditWindow.EndEdit calls releaseCapture on the <input type=“text”/> element to release the mouse capture, hides the element, and calls the callback function that was specified to the EditWindow constructor. If the value was not committed or if the value has not changed, the callback is called with a null value. Otherwise, it is called with the new edited value. GraphBehavior's callback then processes the edited value if it is not null to perform the axis range change.

Whether the user zooms or edits an axis range, GraphBehavior uses a client callback to perform the update. GraphBehavior maintains a stack on the client of all of the interactions that have occurred since the previous postback. GraphBehavior uses two types to do this: RemoteMethod and RemoteMethodList. RemoteMethod encapsulates the name of a method as a string and the parameters to the method as a dictionary, where the key is the parameter name and the value is the parameter value. RemoteMethodList provides methods for pushing, popping, removing, and clearing RemoteMethods. RemoteMethodList also provides a way to convert the list of RemoteMethods to an XML document where the root element is “RemoteMethods” and the children of this element are XML representations of RemoteMethods. The XML representation of RemoteMethod is the XML element name is the name of the method, the attribute names of this element are the names of the parameters, and the attribute values of this element are the values of the parameters.

When the GraphBehavior executes the client callback, it sends this XML document as part of the XML HTTP request. It also saves this XML document in a hidden form variable so that the interactions will also be processed when the form is eventually posted back to the server.

A special consideration with this approach is handling undos and resets. GraphBehavior keeps track of the total number of entries (view state+client) that are in the interaction stack. The behavior XML data island contains an attribute called InteractionEntryCount that specifies how many interaction stack entries there are in view state. If the user performs an undo and reset, GraphBehavior first checks the interaction stack entry count and if it is 0, it does nothing. Otherwise, it will add a RemoteMethod to the RemoteMethodList that indicates that either an undo or reset should be executed and send the action with the XML document as part of the XML HTTP request. When the XML HTTP request has completed, GraphBehavior will evaluate the interaction stack entries for optimization opportunities. If the last interaction was a reset operation, it will clear the client interaction stack. If the last interaction was an undo operation, it will perform a reverse loop on the client interaction stack to find the last undoable interaction and if one is available, GraphBehavior will remove the undoable interaction and pop the undo interaction from the client stack.

The XML document that is sent to the server in the XML HTTP request contains the accumulated set of interactions that have occurred since the previous postback. This XML document is passed as the event argument to the ASP.NET graph's implementation of ICallbackEventHandler.RaiseCallbackEvent, which calls an internal method called DispatchRemoteMethods. DispatchRemoteMethods iterates over the XML elements and calls methods on the graph to execute the associated interaction. The following list describes the possible XML elements and how the graph interprets the element and its attributes:

ZoomAroundPoint—Converts the X and Y attribute values to integers, passes the converted values to the graph's PointToVirtual method, then passes the virtual point to the graph's ZoomAroundPoint method.

ZoomXY—Converts the Left, Top, Right, and Bottom attribute values to integers, creates a Rectangle from these values, passes the Rectangle to the graph's RectangleToVirtual method, then passes the virtual rectangle to the graph's ZoomXY method.

UndoZoomPan—Calls the graph's UndoZoomPan method.

ResetZoomPan—Calls the graph's ResetZoomPan method.

UpdateRange—Converts the NewLabel attribute value to a string, the OldValue attribute value to a double, the EditRangeValue attribute value to an EditRangeValue, the AxisType attribute value to an XYAxisType, and the Index attribute value to an integer. EditRangeValue and XYAxisType are internal Measurement Studio types. These converted values are then passed to the XYGraphManager.UpdateRange method.

Once the interactions have been processed, the ASP.NET graph re-renders the image and hands it off to image state management. Depending on the interactions, the graph's behavior data may have changed. For example, an edited axis label will result in a wider label, a wider label will result in a smaller plot area, etc. Therefore, the graph re-renders the XML data island for the client behavior data. This XML data island contains an additional piece of information that is not in the original XML data island, and that is a URL for the re-rendered image. The XML data island is the result of the client callback and is the return value of the ICallbackEventHandler.RaiseCallbackEvent implementation.

A JavaScript callback function on GraphBehavior is called with the client callback result. This callback function creates an MSXML.DOMDocument object on the client to parse the XML document and re-initializes GraphBehavior's behavior data. Finally, the callback function sets the image of the control on the client to the URL of the re-rendered image to update the image on the client.

Auto-Refresh Control

The Auto-Refresh control is a non-visual control that renders nothing during the Render phase of the page life cycle. Its purpose is to enrich the client-side behavior of other controls via page startup scripts that manage partial page updates via XML HTTP requests instead of postbacks. The Auto-Refresh control has a collection of controls whose updates it manages. The Auto-Refresh control registers page startup scripts that are responsible for updating the controls based on a trigger on the client. When this trigger occurs, the an XML HTTP request is sent to the server and the server raises a Refresh event on the server. Page developers implement event handlers for this event to execute updates to server controls. The event arguments will contain a collection of controls that the user can add to or remove from. This collection of controls represents the controls that will be updated on the client. After the Refresh event has fired, the Auto-Refresh control iterates through the collection of controls that are left in the Refresh event arguments and calls each control's implementation of IRefreshCallbackEventHandler.RaiseRefreshCallbackEvent to retrieve a description of how the client representation of the control should be updated. The Auto-Refresh control then constructs a response to the XML HTTP request with this information, the Auto-Refresh client script receives this response, and then updates the client controls based on the information that is in the response.

It is noted that various embodiments may further include receiving, sending or storing instructions and/or data implemented in accordance with the foregoing description upon a carrier medium.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for graphing data for a web application, the method comprising:
a web browser on a client computer system requesting a web page from a server computer system;
the server computer system returning the web page to the client computer system, wherein returning the web page comprises returning first information useable to display a graph illustrating first data and returning code associated with the graph;
the web browser on the client computer system displaying the web page, wherein displaying the web page comprises displaying the graph illustrating the first data;
the web browser receiving user input to the displayed graph, wherein the user input requests second data to be illustrated in the graph;
the code associated with the graph operating to asynchronously request the server computer system to return second information useable to re-display the graph to illustrate the second data in response to the user input;
the server computer system returning the second information to the client computer system in response to the asynchronous request; and
the code associated with the graph operating to re-display the graph to illustrate the second data based on the second information, wherein re-displaying the graph is performed without re-displaying the entire web page.

2. The method of claim 1,
wherein performing the request to return the second information asynchronously enables the graph to be re-displayed without blocking user interaction with the web page.

3. The method of claim 1,
wherein the web page returned to the client computer system does not require the web browser on the client computer system to have any plug-in software installed in order to achieve said receiving user input to the displayed graph, said asynchronously requesting the server computer system to return the second information useable to re-display the graph to illustrate the second data, and said re-displaying the graph to illustrate the second data without re-displaying the entire web page.

4. The method of claim 1,
wherein the web browser comprises a standard web browser;
wherein the web page returned to the client computer system does not require the web browser on the client computer system to have any software installed other than software installed during a standard installation of the web browser in order to achieve said receiving user input to the displayed graph, said asynchronously requesting the server computer system to return the second information useable to re-display the graph to illustrate the second data, and said re-displaying the graph to illustrate the second data without re-displaying the entire web page.

5. The method of claim 1,
wherein the web browser comprises an Internet Explorer web browser of version 5.0 or above;
wherein the web page returned to the client computer system does not require the Internet Explorer web browser on the client computer system to have any software installed other than software installed during a standard installation of the Internet Explorer web browser in order to achieve said receiving user input to the displayed graph, said asynchronously requesting the server computer system to return the second information useable to re-display the graph to illustrate the second data, and said re-displaying the graph to illustrate the second data without re-displaying the entire web page.

6. The method of claim 1,
wherein the code associated with the graph comprises scripting code that is interpreted by the web browser.

7. The method of claim 6,
wherein said receiving the user input to the displayed graph, said asynchronously requesting the server computer system to return the second information useable to re-display the graph to illustrate the second data, and said re-displaying the graph to illustrate the second data without re-displaying the entire web page are accomplished by the scripting code that is interpreted by the web browser.

8. The method of claim 1,
wherein the first data comprises first measurement data acquired from a measurement device, wherein said displaying the graph illustrating the first data comprises displaying a graph illustrating the first measurement data;
wherein the method further comprises the server computer system communicating with a measurement application to receive the first measurement data, wherein the measurement application controls the measurement device to acquire the measurement data.

9. The method of claim 8,
wherein the measurement device acquires the measurement data based on an electrical signal from a sensor coupled to a physical system.

10. The method of claim 1,
wherein said displaying the graph illustrating the first data comprises displaying one of:
a two-dimensional plot of the first data; or
a three-dimensional plot of the first data.

11. The method of claim 1,
wherein said receiving the user input to the displayed graph comprises receiving user input to the displayed graph in order to select a subset of the first data illustrated in the graph, wherein selecting the subset of the first data requests the subset of the first data to be illustrated in the graph at a larger scale;
wherein said server computer system returning the second information to the client computer system comprises the server system returning information useable to re-display the graph to illustrate the subset of the first data at the larger scale;
wherein said code associated with the graph operating to re-display the graph to illustrate the second data comprises the code associated with the graph operating to re-display the graph to illustrate the subset of the first data at the larger scale, based on the second information received from the server computer system.

12. The method of claim 11,
wherein said receiving the user input to the displayed graph in order to select the subset of the first data illustrated in the graph comprises receiving user input to draw a box around the subset of the first data illustrated in the graph.

13. The method of claim 11,
wherein in re-displaying the graph to illustrate the subset of the first data at the larger scale, the code associated with the graph is operable to perform an animation effect to animate a transition from the first data illustrated in the graph to the subset of the first data.

14. The method of claim 1,
wherein the graph includes a first axis, wherein said displaying the graph illustrating the first data comprises displaying the graph with a first axis range for the first axis;
wherein said receiving the user input to the displayed graph comprises receiving user input to change the first axis range to a new axis range, wherein changing the first axis range to the new axis range requests data within the new axis range to be illustrated in the graph;
wherein said server computer system returning the second information to the client computer system comprises the server system returning information useable to re-display the graph to illustrate the data within the new axis range;
wherein said code associated with the graph operating to re-display the graph to illustrate the second data comprises the code associated with the graph operating to re-display the graph to indicate the new axis range and to illustrate the data within the new axis range, based on the second information received from the server computer system.

15. The method of claim 1,
wherein in re-displaying the graph to illustrate the second data, the code associated with the graph is operable to perform an animation effect to animate a transition from the first data illustrated in the graph to the second data illustrated in the graph.

16. A server computer system comprising:
a processor; and
a memory storing program instructions;
wherein the processor is operable to execute the program instructions stored in the memory in order to implement:
receiving a request for a web page from a web browser executing on a client computer system; and
returning the web page to the web browser, wherein returning the web page comprises returning first information useable to display a graph illustrating first data and returning code associated with the graph;
wherein the web browser on the client computer system is operable to:
display the web page, wherein displaying the web page comprises displaying the graph illustrating the first data; and
receive user input to the displayed graph, wherein the user input requests second data to be illustrated in the graph;
wherein the code associated with the graph is operable to asynchronously request the server computer system to return second information useable to re-display the graph to illustrate the second data in response to the user input;
wherein the server computer system is operable to return the second information to the client computer system in response to the asynchronous request; and
wherein the code associated with the graph is operable to re-display the graph to illustrate the second data based on the second information, wherein re-displaying the graph is performed without re-displaying the entire web page.

17. A method for creating a web application for graphing data, the method comprising:
associating a software component with a web page of the web application so that the software component executes on a server computer system in response to requests to access the web page;
wherein, in response to a request from a web browser to receive the web page, the software component executes to generate at least a portion of the web page, wherein generating the at least a portion of the web page comprises:
generating first information useable by the web browser to display a graph illustrating first data; and
generating code associated with the graph;
wherein the web browser displays the graph illustrating the first data, based on the first information;
wherein, in response to receiving user input to the graph requesting second data to be illustrated in the graph, the code associated with the graph operates to asynchronously request the server computer system to return second information useable to re-display the graph to illustrate the second data;
wherein the software component executes to generate the second information in response to the asynchronous request;
wherein the code associated with the graph operates to re-display the graph to illustrate the second data based on the second information, wherein re-displaying the graph is performed without re-displaying the entire web page.

18. The method of claim 17,
wherein the software component is provided to a developer as a re-useable software component for graphing data in web applications.

19. The method of claim 18,
wherein said associating the software component with the web page comprises associating the software component with the web page in response to user input by the developer;
wherein the developer does not need to write program code for the software component to implement said generating the first information useable by the web browser to display the graph and said generating the code associated with the graph.

20. The method of claim 17,
wherein the software component comprises a re-useable ASP.NET control for graphing data in web applications.
